(19) United States
(12) Patent Application Publication
(10) Pub. No.: US 2023/0172210 A1
(43) Pub. Date: Jun. 8, 2023

(54) PROMETHRIN COMPOSITION IN FORM OF MICROEMULSION

(71) Applicant: RED SURCOS COLOMBIA S.A.S., Bogotá (CO)

(72) Inventor: Félix Silvestre GALÁN ROMANO, Buenos Aires (AR)

(21) Appl. No.: 17/923,858

(22) PCT Filed: Jul. 30, 2020
(86) PCT No.: PCT/IB2020/057235

§ 371 Date: Nov. 7, 2022

(30) Foreign Application Priority Data
May 8, 2020 (AR) P20200101331

(51) Int. Cl. A01N 53/00; A01N 25/04; A01N 25/30; A01N 39/04; A01N 57/20

(52) U.S. Cl. CPC A01N 53/00; A01N 25/04; A01N 25/30; A01N 39/04; A01N 57/20

(57) ABSTRACT

Disclosed is a composition of promethrin in form of a microemulsion including from 15 to 20% by volume by weight of promethrin, a non-polar solvent or non-polar solvent mixture including from 47 to 58% w/v, a polar solvent or polar solvent mixture that includes from 2 to 21% w/v, a 60% or 70% w/w anionic surfactant including from 2.4 to 4.33% w/v, an adjuvant from 0 to 4.70% w/v, and a mixture of nonionic surfactants from 9.66 to 21.00% w/v.

### FIELD OF THE INVENTION

The present invention is included in the field of herbicidal formulations of the chemical compound promethrin (N²,N⁴-diisopropyl-6-methylthio-1,3,5-triazine-2,4-diamine) especially in form of microemulsion at low concentrations.

### OBJECT OF THE INVENTION

The object of the present invention is the provision of an herbicidal composition of the active ingredient promethrin in low concentration in form of a micro-emulsion that unexpectedly requires a lower dose of application of the active ingredient per unit of cultivation area to which it is applied achieving equal or better benefits than concentrated commercial formulations thereof.

### BACKGROUND OF THE INVENTION

It is common to find in the agrochemical market the herbicide promethrin marketed as a 50% concentrated suspension (Gesagard % 50 concentrated suspension, Prometrex FW 50% SC, among others).

In general, commercial presentations for the control of promethrin as soluble liquid in equivalents in grams of active ingredient per kg or liter of presentation are commercialized in 480; as wettable powder 500 and as suspension concentrated 500 (see commercial presentations of promethrin on the website https://www-ecured.cu/Prometrina).

The Merck Index 2000 indicates as the first patents related to the product promethrin, patents CH 337019, U.S. Pat. No. 2,909,420, FR1372089 and U.S. Pat. No. 3,207,756, among others.

Patents FR1372089 and U.S. Pat. No. 3,207,756 refer to methods of synthesis of promethrin, where compositions of said herbicide are not disclosed.

The first patent for promethrin CH 337019 revealed the formulation of the active ingredient using xylene, cyclohexanone, surfactants, fatty acids. However, all the formulations disclosed in said patent are to generate emulsifiable concentrates and the examples are directed to wettable powders, there are no formulations of the microemulsion type in the same at concentrations that demonstrate that they can be applied at a lower dose on the crops having an effect at least the same as a concentrated composition.

U.S. Pat. No. 2,909,420 refers to compositions for inhibiting the growth of plants that comprise promethrin among its active ingredients; however, no microemulsions of promethrin are disclosed in said patent.

### SUMMARY OF THE INVENTION

The present invention contemplates a composition of promethrin in form of a microemulsion comprising from 15 to 20% by volume by weight of promethrin, a non-polar solvent or solvent mixture comprising from 47 to 58% w/v, a polar solvent or mixture of polar solvent comprising from 2 to 21% w/v, an anionic surfactant 60% or 70% w/w comprising from 2.4 to 4.33% w/v, an adjuvant from 0 to 4.70% w/v, and a mixture of nonionic surfactants from 9.66 to 21.00% w/v.

In the above microemulsion composition of promethrin according to one of your preferences, the non-polar solvent or solvent mixture comprises xylene and/or cyclohexanone and/or ethyl acetate and/or dimethylamide of natural fatty acids such as coconut acids with 8 to 10 carbon atoms.

In the developed microemulsion composition of promethrin, the polar solvent or solvent mixture comprises water and/or propylene glycol.

In the composition of promethrin in form of a microemulsion according to one of the preferences, the 60% or 70% w/w anionic surfactant is calcium dodecylbenzenesulfonate.

In the microemulsion composition of promethrin according to another preference, the mixture of nonionic surfactant comprises castor oil ethoxylated with 36 moles of ethylene oxide and/or tristyryl phenol ethoxylated with 20 moles of ethylene oxide and/or tridecyl alcohol ethoxylated with 6 moles of ethylene oxide and/or polyalkylene glycol ether polymer.

In the microemulsion composition of promethrin according to a variant thereof, the adjuvant is a soybean oil fatty acid methyl ester.

In the composition of promethrin in form of a microemulsion according to any of the proposed variants, the concentration of promethrin is 18.5% w/v.

One of the preferred variants of the microemulsion composition of promethrin comprises the following component ratio: 18.5% w/v of promethrin, 39% w/v of xylene, 16.5% w/v of cyclohexanone, 2% w/v of ethyl acetate, 2% w/v of soybean oil fatty acid methyl ester, 4.33% w/v of isotridecyl alcohol ethoxylated with 6 moles of ethylene oxide, 4.33% w/v of calcium dodecylbenzenesulfonate (60% w/w), 4.33% w/v of castor oil ethoxylated with 36 moles of ethylene oxide, 1.0% w/v of tristyryl phenol ethoxylated with 20 moles of ethylene oxide and 5% w/v of propylene glycol.

Another preferred variant of the microemulsion composition of promethrin comprises the following component ratio: 18.5% w/v of promethrin, 43% w/v of xylene, 17% w/v of cyclohexanone, 2% w/v of ethyl acetate, 0% w/v of soybean oil fatty acid methyl ester, 4.33% w/v of tridecyl alcohol ethoxylated with 6 moles of ethylene oxide, 4.33% w/v of calcium dodecylbenzenesulfonate (60% w/w), 4.33% w/v of castor oil ethoxylated with 36 moles of ethylene oxide, 1.0% w/v of tristyryl phenol ethoxylated with 20 moles of ethylene oxide and 2% w/v of propylene glycol.

Among the variants of the composition of promethrin in form of a microemulsion there is also one that comprises the following ratio of components: 18.5% w/v of promethrin, 46.6% w/v of xylene, 3.5% of water, 4.70% w/v of soybean oil fatty acid methyl ester, 2.40% w/v of calcium dodecylbenzenesulfonate (60% w/w), 4.70% w/v of polymeric polyalkylene glycol ether, 12.20% w/v of tristyryl phenol ethoxylated with 20 moles of ethylene oxide and 2.80% w/v of propylene glycol.

Another variant of the microemulsion composition of promethrin according to the present document comprises the following component ratio: 18.5% w/v of promethrin, 47% w/v of xylene, 3.50% w/v of water, 2% w/v of soybean oil fatty acid methyl ester, 5.0% w/v of polymeric polyalkylene glycol ether, 16.0% w/v of triestyryl phenol ethoxylated with 20 moles of ethylene oxide and 21.0% w/v of propylene glycol.

Another variant of the composition of promethrin in form of a microemulsion according to the present embodiment comprises the following ratio of components: 18.5% w/v of promethrin, 47.70% w/v of xylene, 2.00% w/v of water, 3.70% w/v of soybean oil fatty acid methyl ester, 1.50% w/v of tridecyl alcohol ethoxylated with 6 moles of ethylene oxide, 2.40% w/v of calcium dodecylbenzenesulfonate (70% w/w), 4.70% w/v of polymeric polyalkylene glycol ether, and 12.2% w/v of tristyryl phenol ethoxylated with 20 moles of ethylene oxide.

An embodiment of the composition of promethrin in form of a microemulsion according to the present description comprises the following component ratio 18.5% w/v of promethrin, 49.0% w/v of coconut fatty acid dimethylamide of 8-10 carbon atoms, 1.00% w/v of soybean oil fatty acid methyl ester, 1.5% w/v of propylene glycol, 15.00% w/v of triestyryl phenol ethoxylated with 20 moles of ethylene oxide, 3.30% w/v of calcium dodecylbenzenesulfonate (70% w/w), 6.00% w/v of polymeric polyalkylene glycol ether, and 2.00% w/v of water.

The composition of promethrin in form of a microemulsion in other variants comprises the following component ratio: 18.5% w/v of promethrin, 48.0% w/v of coconut fatty acid dimethylamide of 8-10 carbon atoms, 2.00% w/v of soybean oil fatty acid methyl ester, 2.5% w/v of propylene glycol, 16.00% w/v of triestyryl phenol ethoxylated with 20 moles of ethylene oxide, 2.50% w/v of calcium dodecylbenzenesulfonate (70% w/w), 5.00% w/v of polymeric polyalkylene glycol ether, and 2.50% w/v of water.

Among the variants of the composition of promethrin in form of a microemulsion according to the present document, there is one that comprises the following component ratio: 15.0% w/v of promethrin, 40% w/v of xylene, 17.80% w/v of cyclohexanone, 2.00% w/v of ethyl acetate, 2.00% w/v of soybean oil fatty acid methyl ester, 4.33% w/v of tridecyl alcohol ethoxylated with 6 moles of ethylene oxide, 4.33% w/v of calcium dodecylbenzenesulfonate (60% w/w), 4.33% w/v of castor oil ethoxylated with 36 moles of ethylene oxide, 1.0% w/v detriestiril phenol ethoxylated with 20 moles of ethylene oxide and 5% w/v of propylene glycol.

Also preferred is the composition of promethrin in form of a microemulsion according to the present application, which comprises the following component ratio: 20.00% w/v of promethrin, 39% w/v of xylene, 15% w/v of cyclohexanone, 2% w/v of ethyl acetate, 2% w/v of soybean oil fatty acid methyl ester, 4.33% w/v of tridecyl alcohol ethoxylated with 6 moles of ethylene oxide, 4.33% w/v of calcium dodecylbenzenesulfonate (60% w/w), 4.33% w/v of castor oil ethoxylated with 36 moles of ethylene oxide, 1.0% w/v of triestryl phenol ethoxylated with 20 moles of ethylene oxide and 5% w/v of propylene glycol.

In another variant of the invention, the composition of promethrin in form of a microemulsion is combined with 2,4-D and/or glyphosate compositions before dilution with water in application broths.

In this last variant of the invention, the described composition of promethrin in form of a microemulsion comprises compositions with a concentration of 18.5% w/v, 15% w/v and 20% w/v; the glyphosate composition comprises glyphosate potassium salt 54% w/v and the 2.4-D composition comprises 2.4-D 30% w/v of microemulsion.

In this previously described variant of the promethrin composition in form of a microemulsion, the ratio of the combination of promethrin composition:glyphosate composition in a binary mixture is 58.3:41.7 v/v.

In this previously described variant of the promethrin composition in form of a microemulsion, the ratio of the combination of promethrin composition:2.4-D composition in a binary mixture is 72.9:27.1 v/v.

Finally, in this previously described variant of the promethrin composition in form of a microemulsion, the ratio of the combination of promethrin composition:glyphosate composition:2.4-D composition in a ternary mixture is 47.9:34.2:17.9 v/v.

### BRIEF DESCRIPTION OF THE DRAWINGS

FIG. 1: shows rainfalls during the period under study of partial campaign 15-16 and historical comparison in Freyre Site.

FIG. 2: shows in Var 1. Results for emergences of Lolium multiflorum, number of seedlings/meter² post-treatment (mean absolute values of three repetitions, 15 DDA and 30 DDA) Lolium multiflorum.

FIG. 3: shows in Var 2. Results for emergences of Eleusine indica, number of seedlings/meter² post-treatment (mean absolute values of three repetitions, 15 DDA and 30 DDA)Eleusine indica.

FIG. 4: shows in Var 3. Results for emergences of Setaria sp., number of seedlings/meter² post-treatment (mean absolute values of three repetitions, 15 DDA and 30 DDA) Setaria sp.

FIG. 5: shows in Var 4. Results for emergences of Amaranthus quintensis, number of seedlings/meter² post-treatment (mean absolute values of three repetitions, 15 DDA and 30 DDA)Amaranthus quintensis.

FIG. 6: shows in Var 5. Results for emergences of Gomphrena Pulcella, number of seedlings/meter² post-treatment (mean absolute values of three repetitions, 15 DDA and 30 DDA) Gomphrena Pulcella.

FIG. 7: shows in Graph 1 Rainfalls and evapotranspiration in Nelson site during the period under study of partial campaign 15-16 and historical comparison.

FIG. 8: shows 3 graphs of Temperature and Rainfall in months from November 2017 to January 2018 in trial sites as Balcarce, Cavanagh and Margarita.

FIG. 9: shows the control exerted by the herbicide promethrin 18.5% ME on weeds present in a sunflower crop in the Balcarce locality (Buenos Aires). Different letters indicate significant differences between treatments according to Fisher LSD (p<0.05). Due to the overlapping of the curves, the number of treatments with equal letters is indicated in parentheses.

FIG. 10: corresponds to other graphics wherein the control exerted by the herbicide promethrin 18.5% ME on weeds present in a sunflower crop in the Balcarce locality (Buenos Aires) is shown. Different letters indicate significant differences between treatments according to Fisher LSD (p<0.05). Due to the overlapping of the curves, the number of treatments with equal letters is indicated in parentheses.

FIG. 11: shows the control exerted by the herbicide promethrin 18.5% ME on weeds present in a sunflower crop in the Balcarce locality (Buenos Aires). Different letters indicate significant differences between treatments according to Fisher LSD (p<0.05). Due to the overlapping of the curves, the number of treatments with equal letters is indicated in parentheses.

FIG. 12: shows the meteorological data in Balcarce, Cavanagh and Margarita from November 2018 to January 2019.

### DETAILED DESCRIPTION OF THE INVENTION

The present invention relates to promethrin compositions in form of a microemulsion with a concentration of the active ingredient between 15 and 20% w/v.

Technical grade promethrin is a solid that is marketed at a concentration of 96%-98% w/w with a very low solubility in water of 33 ppm (mg/L) at 20° C.

The microemulsion compositions are formulations containing very small emulsified oily drops which originate a clear formulation that is thermodynamically stable in a wide range of temperatures because the droplets have a very small size that varies in a range of 0.01 μm to 0.05 μm in diameter. Therefore, unlike other emulsion systems, wherein over time oily droplets can slowly melt causing phase separation, in microemulsion formulations this does not occur.

Microemulsions are made up of immiscible liquids and appropriate amounts of surfactant and co-surfactant.

The present microemulsion formulation of promethrin is composed of immiscible liquids comprising an organic solvent of non-polar formulation comprising a mixture of xylene-ethyl acetate or mixture of xylene-cyclohexanone-ethyl acetate (very poorly soluble in water) or a natural fatty acid dimethylamide such as coconut acids with 8 to 10 carbon atoms marketed as Genagen 4166 and as a polar solvent insoluble with the above organic solvent but soluble in water comprising water or propylene glycol or a propylene glycol-water mixture.

Among the surfactants for the promethrin microemulsion of the present embodiment, the following are preferred: as nonionic surfactant, castor oil ethoxylated with 36 moles of ethylene oxide, for example, that sold under the name Emulsogen EL 360; tristyryl phenol ethoxylated with 20 moles of ethylene oxide with low VOC content for example the one sold under the name Emulsogen TS 200; tridecyl alcohol ethoxylated with 6 moles of ethylene oxide, for example, the one sold under the name Genapol X060. Anionic surfactant is preferred to 60% or 70% w/w of calcium dodecylbenzenesulfonate (FS Ca) in isobutanol.

Polyalkylene glycol ether polymer is also used as a nonionic surfactant, for example, marketed under the name Atlas G5002 L.

The promethrin microemulsion also contains fatty acid methyl esters such as soybean oil as adjuvants; adjuvants give them an anti-evaporation and adherent power to agricultural applications; this property is essential to avoid the separation of active phases into the mixing tank at the time of applying agrochemicals. Based on the above components, the following microemulsions were prepared where the amounts in % w/v are described in the following tables:

### 1) Promethrin Microemulsion 18.5% w/v

| Component | % w/v |
|---|---|
| Xylene | 39.00 |
| Cyclohexanone | 16.50 |
| Ethyl acetate | 2.00 |
| EMAG | 2.00 |
| GT Promethrin (97.5% w/w) | 18.97 |
| Genapol X060 | 4.33 |
| FS Ca 60% in isobutanol | 4.33 |
| Emulsogen EL 360 | 4.33 |
| Emulsogen TS 200 | 1.00 |
| Propylene glycol | 5.00 |

### 2) Promethrin Microemulsion 18.5% w/v

| Component | % w/v |
|---|---|
| Xylene | 43.00 |
| Cyclohexanone | 17 |
| Ethyl acetate | 2.00 |
| EMAG | 0.00 |
| GT Promethrin (97.5% w/w) | 18.97 |
| Genapol X060 | 4.33 |
| FS Ca 60% in isobutanol | 4.33 |
| Emulsogen EL 360 | 4.33 |
| Emulsogen TS 200 | 1.00 |
| Propylene glycol | 2.00 |

### 3) Promethrin Microemulsion 18.5% w/v

| Component | % w/v |
|---|---|
| Xylene | 46.60 |
| Water | 3.50 |
| Ethyl acetate | 0.00 |
| EMAG | 4.70 |
| GT Promethrin (97.5% w/w) | 18.97 |
| Genapol X060 | 0.00 |
| FS Ca 70% in isobutanol | 2.40 |
| Atlas G50002L | 4.70 |
| Emulsogen TS 200 | 12.20 |
| Propylene glycol | 2.80 |

### 4) Promethrin Microemulsion 18.5% w/v

| Component | % w/v |
|---|---|
| Xylene | 47.00 |
| Water | 3.50 |
| Ethyl acetate | 0.00 |
| EMAG | 2.00 |
| GT Promethrin (97.5% w/w) | 18.97 |
| Genapol X060 | 0.00 |
| FS Ca 70% in isobutanol | 2.50 |
| Atlas G50002L | 5.00 |
| Emulsogen TS 200 | 16.00 |
| Propylene glycol | 21.00 |

### 5) Promethrin Microemulsion 18% w/v

| Component | % w/v |
|---|---|
| Xylene | 47.70 |
| Water | 2.00 |
| Ethyl acetate | 0.00 |
| EMAG | 3.70 |
| GT Promethrin (97.7% w/w) | 18.42 |
| Genapol X060 | 1.50 |
| FS Ca 70% in isobutanol | 2.40 |
| Atlas G50002L | 4.70 |
| Emulsogen TS 200 | 12.20 |
| Propylene glycol | 0.00 |

### 6) Promethrin Microemulsion 18.5% w/v

| Component | % w/v |
|---|---|
| Genagen 4166 | 49.00 |
| Water | 2.00 |
| Ethyl acetate | 0.00 |
| EMAG | 1.00 |
| GT Promethrin (97.7% w/w) | 18.90 |
| Genapol X060 | 0.00 |
| FS Ca 70% in isobutanol | 3.30 |
| Atlas G50002L | 6.00 |
| Emulsogen TS 200 | 15.00 |
| Propylene glycol | 1.50 |

### 7) Promethrin Microemulsion 18.5% w/v

| Component | % w/v |
|---|---|
| Genagen 4166 | 48.00 |
| Water | 2.00 |
| Ethyl acetate | 0.00 |
| EMAG | 2.00 |
| GT Promethrin (97.5% w/w) | 18.97 |
| Water | 2.5 |
| FS Ca 70% in isobutanol | 2.5 |

### 8) Formula at 15% w/v

| Component | % w/v |
|---|---|
| Xylene | 40.00 |
| Cyclohexanone | 17.80 |
| Ethyl acetate | 2.00 |
| EMAG | 2.00 |
| GT Promethrin (97% w/w) | 15.50 |
| Genapol X060 | 4.33 |
| FS Ca 60% in isobutanol | 4.33 |
| Emulsogen EL 360 | 4.33 |
| Emulsogen TS 200 | 1.00 |
| Propylene glycol | 5.00 |

### 9) Formula at 20% w/v

| Component | % w/v |
|---|---|
| Xylene | 39.00 |
| Cyclohexanone | 15.50 |
| Ethyl acetate | 2.00 |
| EMAG | 2.00 |
| GT Promethrin (97% w/w) | 20.60 |
| Genapol X060 | 4.33 |
| FS Ca 60% in isobutanol | 4.33 |
| Emulsogen EL 360 | 4.33 |
| Emulsogen TS 200 | 1.00 |
| Propylene glycol | 5.00 |

In all the previous formulations, the technical grade drug was added in order to obtain the desired weight-by-volume concentrations.

The above microemulsion formulations showed excellent stability, suitably passing the emulsion tests in water without component separation, as demonstrated in the table presented at the end of the present description.

### Comparative Tests

With the previous microemulsion formulations, the following tests were performed:

1) Comparative Test of Herbicides in Sunflower Preemergence (Wide Leaf) with Promethrin 18.5% ME

Trial design: Complete random blocks with plots 3 m wide by 10 m long.

### Treatments Proposed:

| No. | Treatments |
|---|---|
| 1 | Absolute control: without control |
| 2 | Dose 1: 2.5 l/ha Promethrin 18.5% ME |
| 3 | Dose 2: 3.5 l/ha Promethrin 18.5% ME |
| 4 | Dose 3: 4 l/ha Promethrin 18.5% ME |
| 5 | Dose 4: 5 l/ha Promethrin 18.5% ME |
| 6 | Chemical control: 2 l/ha Promethrin 50% SC |

### Work Report:

a. Crop: Paradise Sunflower 1000 CL Plus planted

b. Site: La Dulce (Necochea district) Province of Buenos Aires.

c. Soil Moisture: Good soil moisture but very little stubble coverage

d. Characteristics of the application: The application was made the day after sowing. A 35 lb CO₂ constant pressure manual backpack was used with 11002 tablets and an application volume of 140 L/ha.

The tailwind was of 20 km/h, relative humidity of 39% and 32° C. of room temperature.

e. Weeds present: The lot was clean at the time of application due to a control carried out with glyphosate 35 days before. But the presence of Sonchus oleraceus SONOL “cerraja” and Euphorbia dentata “Lecheron” was known in a certain sector.

f. Measured variables: 35 days after application and 76 days after application, visual control evaluations were performed for each weed present. The data were subjected to an analysis of variance and the means were compared with the Fisher test (DMS) with a p<0.05.

g. Results

The selectivity of all the doses on the sunflower was very notable. No morphological symptoms of phytotoxicity were seen. Lecheron controls were very good for all doses evaluated (Table 1). In dose 1 only a few isolated plants remained and the best treatment for this species was with dose 4.

TABLE 1
evaluation in % of control of Lecheron 35 days after application

| No. | Treatments | Lecheron 35 days | | | |
|---|---|---|---|---|---|
| 1 | Absolute control: without | 0.00 | A | | |
| | control | | | | |
| 2 | Dose 1: 2.5 l/ha Promethrin 18.5% | 90.00 | | B | |
| | ME | | | | |
| 3 | Dose 2: 3.5 l/ha Promethrin 18.5% | 94.67 | | B | C |
| | ME | | | | |
| 4 | Dose 3: 4 l/ha Promethrin 18.5% | 94.67 | | B | C |
| | ME | | | | |
| 5 | Dose 4: 5 l/ha Promethrin 18.5% | 99.00 | | | C |
| | ME | | | | |
| 6 | Chemical control: 2 l/ha | 97.67 | | | C |
| | Promethrin 50% SC | | | | |
| | CV % | 3.80 | | | |
| | DMS | 5.48 | | | |

Different letters between columns indicate significant differences between treatments.

SONOL controls are shown in Table 2. In general the control was not good for this herbicide. The control increased slightly as the dose was increased but none of the treatments reached 80% control. So it should be mixed with another active ingredient to control this weed.

TABLE 2
evaluation in % of control of Sonchus oleraceus
(SONOL) 35 and 76 days after application

| No. | Treatments | 35 days | | | 76 days | | |
|---|---|---|---|---|---|---|---|
| 1 | Absolute control: without | 00.00 | A | | 00.00 | A | |
| | control | | | | | | |
| 2 | Dose 1: 2.5 l/ha | 68.33 | | B | 71.67 | | B |
| | Promethrin 18.5% ME | | | | | | |
| 3 | Dose 2: 3.5 l/ha | 71.67 | | B | 73.33 | | B |
| | Promethrin 18.5% ME | | | | | | |
| 4 | Dose 3: 4 l/ha Promethrin | 74.33 | | B | 73.33 | | B |
| | 18.5% ME | | | | | | |
| 5 | Dose 4: 5 l/ha Promethrin | 75.00 | | B | 76.00 | | B |
| | 18.5% ME | | | | | | |
| 6 | Chemical control: 2 l/ha | 73.33 | | B | 76.00 | | B |
| | Promethrin 50% SC | | | | | | |
| | CV % | 7.03 | | | 4.18 | | |
| | DMS | 7.73 | | | 4.69 | | |

Different letters between columns indicate significant differences between treatments.

### Final Comments

The product showed very good selectivity in the crop.
Lecheron's control with promethrin was remarkably good, even at the lowest doses.
For Sonchus the control was low, although it increased with the increase in dose and it was unable to control it.

### 2) Evaluation of Promethrin 18.5% Microemulsion in Preemergence Treatments in the Sunflower Crop in Full Coverage, Evaluated in the Control of Annual Grass Weeds of Common Presence in the Pampas Region, Susceptible to the Chemical Molecule Under Study

Trial design: Plots of 10 m×4 m, with 3 replicates per treatment.

### Treatments Proposed:

| Treat. No. | TREATMENT |
|---|---|
| 1 | Absolute control (without application) |
| 2 | Dose 1: 2.5 1/ha Promethrin 18.5% ME |
| 3 | Dose 2: 3.5 1/ha Promethrin 18.5% ME |
| 4 | Dose 3: 4 l/ha Promethrin 18.5% ME |
| 5 | Chemical control: 2 l/ha Promethrin 50% SC |

Work Report:

a. CROP: Application after sowing of the Sunflower crop, prior to the emergence of annual grass weeds, from predecessor Soybean campaign *14-*15. Lot for direct sowing. An early application against weeds from the harvest of the mentioned glyphosate-based crop. Treatments applied on Sep. 27, 2015 (sowing delayed with respect to the usual one for the region due to excess water in the lot under study).

b. SITE: Freyre, District of San Justo, Province of Cordoba, soil use class IVw, environment class 2.

c. CLIMATE CHARACTERISTICS: Lot with signs of excess water during the 14-15 season. Good environmental conditions during the fallow period, as well as a good history of previous weed controls, given the well-known seed bank of the site, the lot used at this stage is a site having good aptitude for the evaluation of the product in question. Ambient temperatures and humidity above the historical values for the months being surveyed.

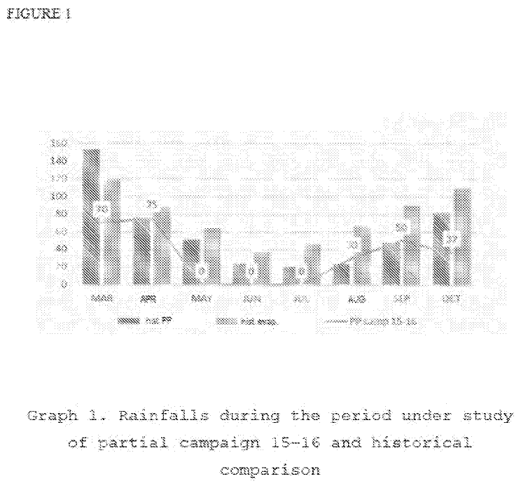

Rainfalls and evapotranspiration of Freyre Site Historical series vs. campaign 15-16 is showed in Graph 1 of FIG. 1.

d. WEED MONITORING: The initial survey was carried out by going across the lot of 60 hectares in total on a biweekly basis, walking it in the form of X and making the reading in a radius of 2 meters per sample, for a total of approximately 1 sample every 10 hectares.

At the time of application, the lot was clean of weeds, 2 days after sowing. Then, sampling was made 15 and 30 days after application, then registering the emergence of controllable seedlings (species and quantity).

e. EMERGENCES REGISTERED AND ASSESSMENT OF APPLICATION

| | Lolium multiflorum | | | Eleusine indica | | | Setaria sp. | |
|---|---|---|---|---|---|---|---|---|
| | 0DDA | 15DDA | 30DDA | 0DDA | 15DDA | 30DDA | 0DDA | 15DDA |
| Absolute control | 0 | 6 | 9 | 0 | 7 | 8 | 0 | 6 |
| Promethrin20ME | 0 | 2 | 4 | 0 | 1 | 4 | 0 | 5 |
| 2.5 lt/ha | | | | | | | | |
| Promethrin20ME | 0 | 2 | 2 | 0 | 0 | 3 | 0 | 4 |
| 3.5 lt/ha | | | | | | | | |
| Promethrin20ME | 0 | 1 | 2 | 0 | 0 | 2 | 0 | 3 |
| 4.0 lt/ha | | | | | | | | |
| Promethrin50ME | 0 | 3 | 4 | 0 | 2 | 3 | 0 | 3 |
| 2.0 lt/ha | | | | | | | | |

| | Setaria sp. | Amaranthus quitensis | | | Gomphrena pulchella | | |
|---|---|---|---|---|---|---|---|
| | 30DDA | 0DDA | 15DDA | 30DDA | 0DDA | 15DDA | 30DDA |
| Absolute control | 7 | 0 | 10 | 12 | 0 | 5 | 7 |
| Promethrin20ME | 6 | 0 | 2 | 3 | 0 | 1 | 1 |
| 2.5 lt/ha | | | | | | | |
| Promethrin20ME | 4 | 0 | 1 | 1 | 0 | 0 | 1 |
| 3.5 lt/ha | | | | | | | |
| Promethrin20ME | 4 | 0 | 0 | 1 | 0 | 0 | 0 |
| 4.0 lt/ha | | | | | | | |
| Promethrin50ME | 5 | 0 | 1 | 1 | 0 | 0 | 0 |
| 2.0 lt/ha | | | | | | | |

Individuals present per square meter, average value of three repetitions of each treatment

f. Statistical Analysis

### Loli15 15 0.84 0.77 34.88

Table of Analysis of Variance (SC type III)

| F.V. | SC | gl | CM | F | p-value |
|---|---|---|---|---|---|
| Model | 51.73 | 4 | 12.93 | 12.93 | 0.0006 |
| Treatment | 51.73 | 4 | 12.93 | 12.93 | 0.0006 |
| Error | 10.00 | 10 | 1.00 | | |
| Total | 61.73 | 14 | | | |

Test: LSD Fisher Alpha = 0.05 DMS = 1.81927
Error: 1.0000 gl: 10

| Treatment | Mean | n | E.E. | | | |
|---|---|---|---|---|---|---|
| Control | 6.33 | 3 | 0.58 | A | | |
| Prome50SC2.0 | 3.00 | 3 | 0.58 | | B | |
| Prome20ME2.5 | 2.33 | 3 | 0.58 | | B | C |
| Prome20ME3.5 | 1.67 | 3 | 0.58 | | B | C |
| Prome20ME4.0 | 1.00 | 3 | 0.58 | | | C |

Different letters indicate significant differences (p≤0.05)

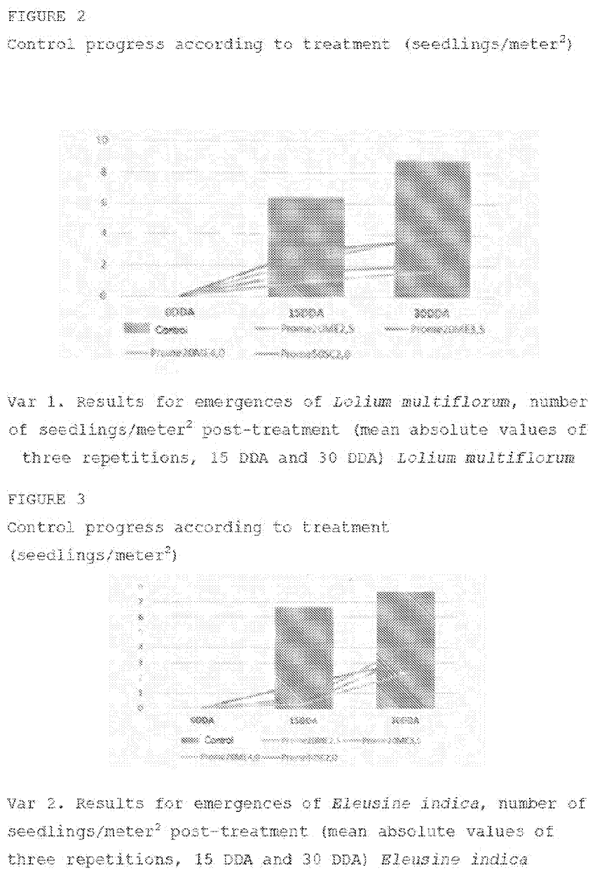

FIG. 2 shows in Var 1. Results for emergences of Lolium multiflorum, number of seedlings/meter² post-treatment (mean absolute values of three repetitions, 15 DDA and 30 DDA) Lolium multiflorum

### Loli30 15 0.94 0.92 19.36

Table of Analysis of Variance (SC type III)

| F.V. | SC | gl | CM | F | p-value |
|---|---|---|---|---|---|
| Model | 94.00 | 4 | 23.50 | 39.17 | <0.0001 |
| Treatment | 94.00 | 4 | 23.50 | 39.17 | <0.0001 |
| Error | 6.00 | 10 | 0.60 | | |
| Total | 100.00 | 14 | | | |

Test: LSD Fisher Alpha = 0.05 DMS = 1.40920
Error: 0.6000 gl: 10

| Treatment | Mean | n | E.E. | | | |
|---|---|---|---|---|---|---|
| Control | 8.67 | 3 | 0.45 | A | | |
| Prome20SC2.0 | 1.00 | 3 | 8.40 | | B | |
| Prome30ME2.5 | 3.67 | 3 | 0.45 | | B | |
| Prome20ME3.5 | 2.00 | 3 | 0.45 | | | C |
| Prome20ME4.0 | 1.67 | 3 | 0.45 | | | C |

Different letters indicate significant differences (p≤0.05)

### Eleu15 15 0.92 0.89 44.29

Table of Analysis of Variance (SC type III)

| F.V. | SC | gl | CM | F | p-value |
|---|---|---|---|---|---|
| Model | 87.60 | 4 | 21.90 | 29.86 | <0.0001 |
| Treatment | 87.60 | 4 | 21.90 | 29.86 | <0.0001 |
| Error | 7.33 | 10 | 0.73 | | |
| Total | 94.93 | 14 | | | |

Test: LSD Fisher Alpha = 0.05 DMS = 1.55793
Error: 0.7333 gl: 10

| | | | |
|---|---|---|---|
| Treatment | Mean | n | E.E. |

| | | | | | |
|---|---|---|---|---|---|
| Control | 6.67 | 3 | 0.49 | A | |
| Prome50SC2.0 | 1.67 | 3 | 0.49 | | B |
| Prome50SC2.5 | 0.67 | 3 | 0.49 | | B |
| Prome50SC4.0 | 0.33 | 3 | 0.49 | | B |
| Prome50SC3.5 | 0.33 | 3 | 0.49 | | B |

Different letters indicate significant differences (p≤0.05)

### Eleu30 15 0.87 0.82 21.99

Table of Analysis of Variance (SC type III)

| F.V. | SC | gl | CM | F | p-value |
|---|---|---|---|---|---|
| Model | 52.93 | 4 | 13.23 | 16.54 | 0.0002 |
| Treatment | 52.93 | 4 | 13.23 | 16.54 | 0.0002 |
| Error | 8.00 | 10 | 0.80 | | |
| Total | 60.93 | 14 | | | |

Test: LSD Fisher Alpha = 0.05 DMS = 1.62720
Error: 0.8000 gl: 10

| Treatment | Mean | n | E.E. | | | |
|---|---|---|---|---|---|---|
| Control | 7.67 | 3 | 0.52 | A | | |
| Prome20ME2.5 | 4.00 | 3 | 0.52 | | B | |
| Prome20ME3.5 | 3.33 | 3 | 0.52 | | B | C |
| Prome50SC2.0 | 3.00 | 3 | 0.52 | | B | C |
| Prome20ME4.0 | 2.33 | 3 | 0.52 | | | C |

Different letters indicate significant differences (p≤0.05)

FIG. 3 shows in Var 2. Results for emergences of Eleusine indica, number of seedlings/meter² post-treatment (mean absolute values of three repetitions, 15 DDA and 30 DDA) Eleusine indica

### Seto15 15 0.74 0.63 18.15

Table of Analysis of Variance (SC type III)

| F.V. | SC | gl | CM | F | p-value |
|---|---|---|---|---|---|
| Model | 16.93 | 4 | 4.23 | 7.06 | 0.0058 |
| Treatment | 16.93 | 4 | 4.23 | 7.06 | 0.0058 |
| Error | 6.00 | 10 | 0.60 | | |
| Total | 22.93 | 14 | | | |

Test: LSD Fisher Alpha = 0.05 DMS = 1.40920
Error: 0.6000 gl: 10

| Treatment | Mean | n | E.E. | | | |
|---|---|---|---|---|---|---|
| Control | 5.67 | 3 | 0.45 | A | | |
| Prome20ME2.5 | 5.33 | 3 | 0.45 | A | B | |
| Prome20ME3.5 | 4.00 | 3 | 0.45 | | B | C |
| Prome50SC2.0 | 3.33 | 3 | 0.45 | | | C |
| Prome20ME4.0 | 3.00 | 3 | 0.45 | | | C |

Different letters indicate significant differences (p≤0.05)

### Seta30 15 0.77 0.67 15.70

Table of Analysis of Variance (SC type III)

| F.V. | SC | gl | CM | F | p-value |
|---|---|---|---|---|---|
| Model | 21.73 | 4 | 5.43 | 8.15 | 0.0034 |
| Treatment | 21.73 | 4 | 5.43 | 8.15 | 0.0034 |
| Error | 6.67 | 10 | 0.67 | | |
| Total | 28.40 | 14 | | | |

Test: LSD Fisher Alpha = 0.05 DMS = 1.48543
Error: 0.6667 gl: 10

| Treatment | Mean | n | E.E. | | | |
|---|---|---|---|---|---|---|
| Control | 7.33 | 3 | 0.47 | A | | |
| Prome20ME2.5 | 5.67 | 3 | 0.47 | | B | |
| Prome50SC2.0 | 4.67 | 3 | 0.47 | | B | C |
| Prome20ME3.5 | 4.33 | 3 | 0.47 | | B | C |
| Prome20ME4.0 | 4.00 | 3 | 0.47 | | | C |

Different letters indicate significant differences (p≤0.05)

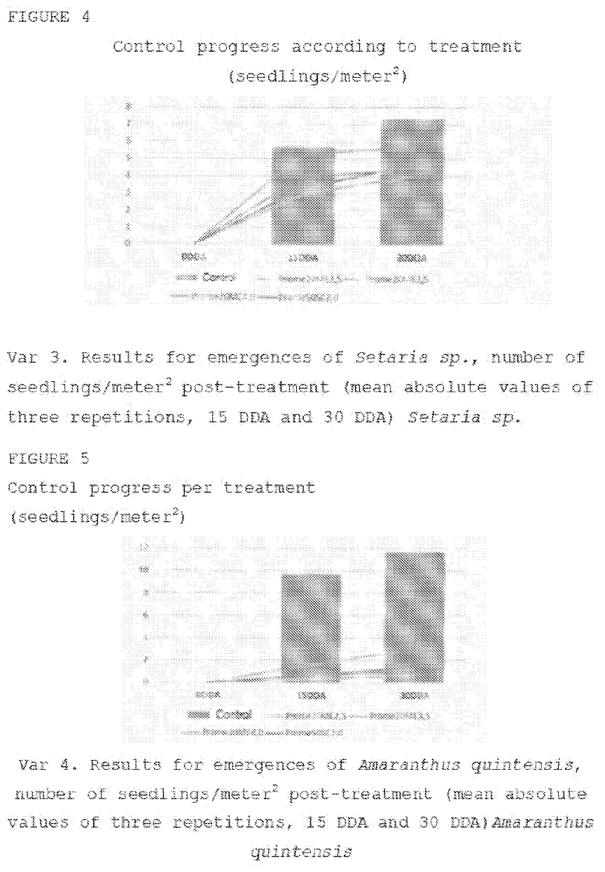

FIG. 4 shows in Var 3. Results for emergences of Setaria sp., number of seedlings/meter² post-treatment (mean absolute values of three repetitions, 15 DDA and 30 DDA)

### Setaria sp.

### Amar15 15 0.93 0.90 47.63

Table of Analysis of Variance (SC type III)

| F.V. | SC | gl | CM | F | p-value |
|---|---|---|---|---|---|
| Model | 190.27 | 4 | 47.57 | 31.02 | <0.0001 |
| Treatment | 190.27 | 4 | 47.57 | 31.02 | <0.0001 |
| Error | 15.33 | 10 | 1.53 | | |
| Total | 205.60 | 14 | | | |

Test: LSD Fisher Alpha = 0.05 DMS = 2.25276
Error: 1.5333 gl: 10

| | | | |
|---|---|---|---|
| Treatment | Mean | n | E.E. |

| | | | | | |
|---|---|---|---|---|---|
| Control | 9.67 | 3 | 0.71 | A | |
| Prome20ME2.5 | 1.67 | 3 | 0.71 | | B |
| Prome50SC2.0 | 0.67 | 3 | 0.71 | | B |
| Prome20ME3.5 | 0.67 | 3 | 0.71 | | B |
| Prome20ME4.0 | 0.33 | 3 | 0.71 | | B |

Different letters indicate significant differences (p≤0.05)

### Amar30 15 0.96 0.95 28.30

Table of Analysis of Variance (SC type III)

| F.V. | SC | gl | CM | F | p-value |
|---|---|---|---|---|---|
| Model | 257.73 | 4 | 64.43 | 64.43 | <0.0001 |
| Treatment | 257.73 | 4 | 64.43 | 64.43 | <0.0001 |
| Error | 10.00 | 10 | 1.00 | | |
| Total | 267.73 | 14 | | | |

Test: LSD Fisher Alpha = 0.05 DMS = 1.81927
Error: 1.0000 gl: 10

| Treatment | Mean | n | E.E. | | | |
|---|---|---|---|---|---|---|
| Control | 11.67 | 3 | 0.58 | A | | |
| Prome20ME2.5 | 3.00 | 3 | 0.58 | | B | |
| Prome50SC2.0 | 1.33 | 3 | 0.58 | | B | C |
| Prome20ME3.5 | 1.00 | 3 | 0.58 | | | C |
| Prome20ME4.0 | 0.67 | 3 | 0.58 | | | C |

Different letters indicate significant differences (p≤0.05)

FIG. 5 shows in Var 4. Results for emergences of Amaranthus quintensis, number of seedlings/meter² post-treatment (mean absolute values of three repetitions, 15 DDA and 30 DDA)Amaranthus quintensis

### Gomp15 15 0.91 0.88 61.15

Table of Analysis of Variance (SC type III)

| F.V. | SC | gl | CM | F | p-value |
|---|---|---|---|---|---|
| Model | 62.93 | 4 | 15.73 | 26.22 | <0.0001 |
| Treatment | 62.93 | 4 | 15.73 | 26.22 | <0.0001 |
| Error | 6.00 | 10 | 0.60 | | |
| Total | 68.93 | 14 | | | |

Test: LSD Fisher Alpha = 0.05 DMS = 1.40920
Error: 0.6000 gl: 10

| | | | |
|---|---|---|---|
| Treatment | Mean | n | E.E. |

| | | | | | |
|---|---|---|---|---|---|
| Control | 5.33 | 3 | 0.45 | A | |
| Prome20ME2.5 | 0.67 | 3 | 0.45 | | B |
| Prome50SC2.0 | 0.33 | 3 | 0.45 | | B |
| Prome20ME4.0 | 0.00 | 3 | 0.45 | | B |
| Prome20ME3.5 | 0.00 | 3 | 0.45 | | B |

Different letters indicate significant differences (p≤0.05)

### Gomp30 15 0.97 0.96 28.69

Table of Analysis of Variance (SC type III)

| F.V. | SC | gl | CM | F | p-value |
|---|---|---|---|---|---|
| Model | 91.73 | 4 | 22.93 | 86.00 | <0.0001 |
| Treatment | 91.73 | 4 | 22.93 | 86.00 | <0.0001 |
| Error | 2.67 | 10 | 0.27 | | |
| Total | 94.40 | 14 | | | |

Test: LSD Fisher Alpha = 0.05 DMS = 0.93947
Error: 0.2667 gl: 10

| Treatment | Mean | n | E.E. | | | |
|---|---|---|---|---|---|---|
| Control | 6.67 | 3 | 0.30 | A | | |
| Prome20ME2.5 | 1.33 | 3 | 0.30 | | B | |
| Prome50ME3.5 | 0.67 | 3 | 0.30 | | B | C |
| Prome50SC2.0 | 0.33 | 3 | 0.30 | | | C |
| Prome50ME4.0 | 0.00 | 3 | 0.30 | | | C |

Different letters indicate significant differences (p≤0.05)

FIG. 6 shows in Var 5. Results for emergences of Gomphrena Pulcella, number of seedlings/meter² post-treatment (mean absolute values of three repetitions, 15 DDA and 30 DDA) Gomphrena Pulcella

General Comments:

The product evaluated under this study had an adequate performance compared to the chemical control, directly dependent on the test dose and the biological features of each weed species being present. Its concentration and formulation features improve the handling of the final product compared to the chemical control.

Although the agronomic recommendation for this chemical molecule in use for grass species particularly indicates the convenience of accompaniments at varying doses of acetochlor to make control more robust, its herbicidal ability in the present study was clearly shown, both for the grasses as for broadleaf weeds present at the site.

3) Evaluation of Promethrin 18.5% Micro Emulsion in Preemergence Treatments on the Sunflower Crop on a Complete Coverage Basis, Evaluated in the Control of Annual Grass Weeds being Commonly Present in the Pampas Region, Susceptible to the Chemical Molecules Under Study.

Trial design: Plots of 10 m×4 m, with 3 repetitions per treatment.

Treatments Proposed:

| Treatment | |
|---|---|
| No. | TREATMENT |
| 1 | Absolute control (without application) |
| 2 | Dose 1: 2.5 1/ha Promethrin 18.5% ME |
| 3 | Dose 2: 3.0 1/ha Promethrin 18.5% ME |
| 4 | Dose 3: 3.5 1/ha Promethrin 18.5% ME |
| 5 | Chemical control: 2 1/ha Promethrin 50% SC |

Work Report:

a. CROP: Application after sowing of the Sunflower crop, prior to the emergence of annual grass weeds, from predecessor Soybean of the first campaign “15-” 16. Lot for direct sowing, with serious flooding problems after the intense rainfalls of April 2016. An early application against weeds from the harvest of the mentioned crop based on Glyphosate. Treatments applied on Aug. 29, 2016.

b. SITE: Nelson, La Capital District, Province of Santa Fe, soil use class IIIwe, environment class 2.

c. CLIMATE CHARACTERISTICS: Lot with serious water excesses during the pre-harvest season 15-16, which did not fully resolve during the fallow period. Good history of previous weed controls despite abundant seed bank on site.

Ambient temperatures and humidity above the historical values for the months being surveyed.

### Rainfalls and Evapotranspiration

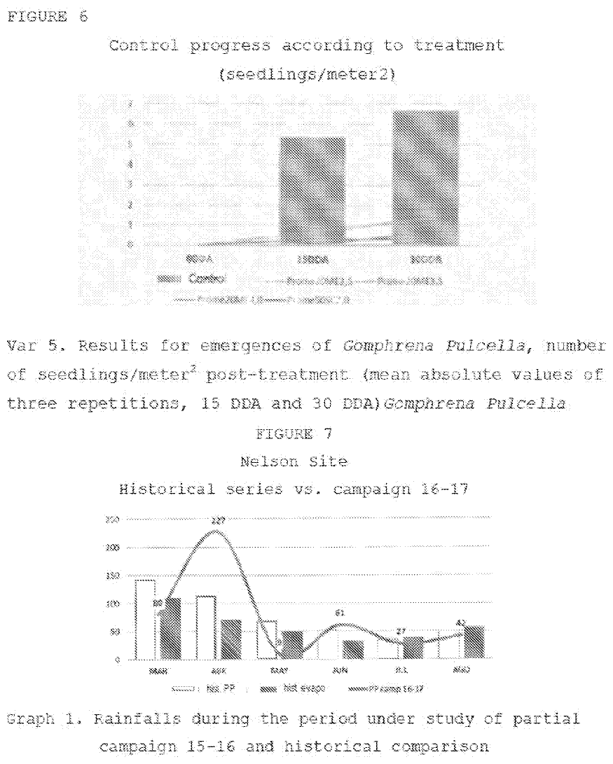

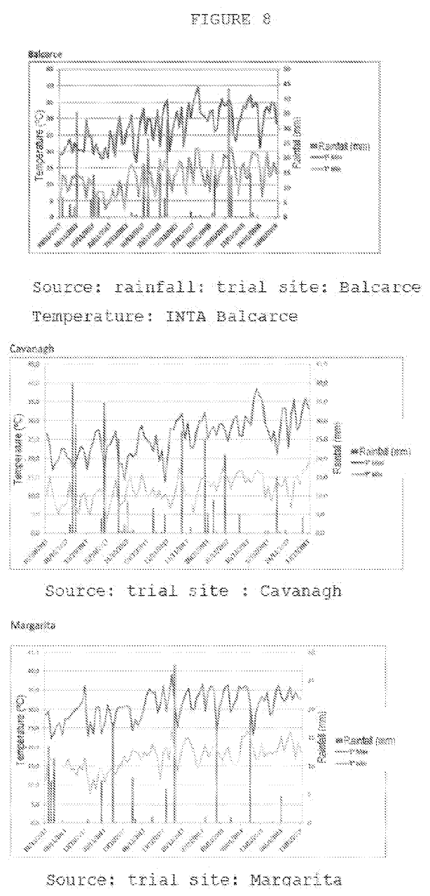

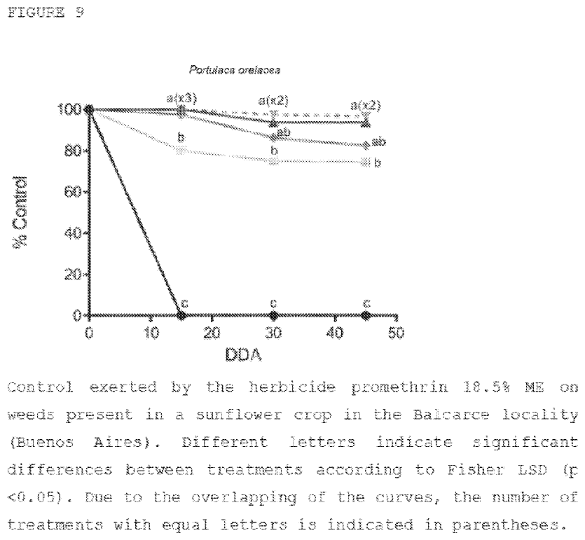

FIG. 7 shows in Graph 1 Rainfalls and evapotranspiration in Nelson site during the period under study of partial campaign 15-16 and historical comparison.

d. WEED MONITORING: The initial survey was carried out by going across the lot of 60 hectares in total on a biweekly basis, walking it in the form of X and making the reading in a radius of 2 meters per sample, for a total of approximately 1 sample every 10 hectares.

At the time of application, the lot was clean of weeds, 2 days after sowing. Then, sampling was made 15 and 30 days after application, then registering the emergence of controllable seedlings (species and quantity).

e. EMERGENCES REGISTERED AND ASSESSMENT OF APPLICATION

| | Lolium multiflorum | | | | | Eleusine indica | | | | |
|---|---|---|---|---|---|---|---|---|---|---|
| | 0 | 15 | % | 30 | % | 0 | 15 | % | 30 | % |
| | DDA | DDA | test | DDA | test | DDA | DDA | test | DDA | test |
| Absolute control | 0 | 5 | 100 | 8 | 100 | 0 | 5 | 100 | 7 | 100 |
| Promethrin 18.5ME 2.5 lt/ha | 0 | 2 | 40 | 3 | 39 | 0 | 1 | 20 | 4 | 60 |
| Promethrin 18.5ME 3 lt/ha | 0 | 1 | 27 | 2 | 26 | 0 | 1 | 13 | 3 | 45 |
| Promethrin 18.5ME 3.5 lt/ha | 0 | 1 | 20 | 2 | 22 | 0 | 0 | 7 | 2 | 35 |
| Promethrin 5OSC 2.0 lt/ha | 0 | 2 | 40 | 3 | 35 | 0 | 1 | 27 | 3 | 45 |

| | Sorghum halepense (riz) | | | | | Sorghum halepense (sem) | | | | |
|---|---|---|---|---|---|---|---|---|---|---|
| | 0 | 15 | | % | | 0 | 15 | | % | |
| | DDA | DDA | | test | | DDA | DDA | | test | |
| Absolute control | 0 | 8 | 100 | 9 | 100 | 0 | 6 | 100 | 6 | 100 |
| Promethrin 18.5ME 2.5 lt/ha | 0 | 1 | 20 | 3 | 43 | 0 | 1 | 18 | 2 | 28 |
| Promethrin 18.5ME 3 lt/ha | 0 | 1 | 13 | 2 | 22 | 0 | 0 | 6 | 1 | 17 |
| Promethrin 18.5ME 3.5 lt/ha | 0 | 0 | 7 | 1 | 9 | 0 | 0 | 0 | 1 | 11 |
| Promethrin 5OSC 2.0 lt/ha | 0 | 1 | 20 | 1 | 13 | 0 | 0 | 6 | 1 | 11 |

Individuals present per square meter, average value of three repetitions of each treatment

f. Statistical analysis:

Table of Analysis of Variance (SC type III)

| F.V. | SC | gl | CK | F | p-value |
|---|---|---|---|---|---|
| Model | 30.27 | 4 | 7.57 | 11.35 | 0.0010 |
| Treatment | 30.27 | 4 | 7.57 | 11.35 | 0.0010 |
| Error | 6.67 | 10 | 0.67 | | |
| Total | 36.93 | 14 | | | |

Test: LSD Fisher Alpha = 0.05 DMS = 1.48543
Error: 0.6667 gl: 10

| | | | |
|---|---|---|---|
| Treatment | Mean | n | E.E. |

| | | | | | |
|---|---|---|---|---|---|
| Control | 5.00 | 3 | 0.47 | A | |
| Prome50SC2 | 2.00 | 3 | 0.47 | | B |
| Prome185ME2.5 | 2.00 | 3 | 0.47 | | B |
| Prome185ME3 | 1.33 | 3 | 0.47 | | B |
| Prome185ME3.5 | 1.00 | 3 | 0.47 | | B |

Means with a common letter are not significantly different (p>0.05)

Variable N R^{a} R^{a} Aj CV

### Loli30 15 0.90 0.86 26.31

Table of Analysis of Variance (SC type III)

| F.V. | SC | gl | CK | F | p-value |
|---|---|---|---|---|---|
| Model | 71.60 | 4 | 17.90 | 22.38 | 0.0001 |
| Treatment | 71.60 | 4 | 17.90 | 22.38 | 0.0001 |
| Error | 8.00 | 10 | 0.80 | | |
| Total | 79.60 | 14 | | | |

Test: LSD Fisher Alpha = 0.05 DMS = 1.62720
Error: 0.8000 gl: 10

| | | | |
|---|---|---|---|
| Treatment | Mean | n | E.E. |

| | | | | | |
|---|---|---|---|---|---|
| Control | 7.67 | 3 | 0.52 | A | |
| Prome185ME2.5 | 3.00 | 3 | 0.52 | | B |
| Prome50SC2 | 2.67 | 3 | 0.52 | | B |
| Prome185ME3 | 2.00 | 3 | 0.52 | | B |
| Prome185ME3.5 | 1.67 | 3 | 0.52 | | B |

Means with a common letter are not significantly different (p>0.05)

### Var 1. Results for Emergences of Lolium multiflorum, Number of Seedlings/Meter2 Post-Treatment (Mean Absolute Values of Three Repetitions, 15 DDA and 30 DDA)

Variable N R^{a} R^{a}Aj CV

### Eleu15 15 0.92 0.88 37.95

Table of Analysis of Variance (SC type III)

| F.V. | SC | gl | CK | F | p-value |
|---|---|---|---|---|---|
| Model | 43.33 | 4 | 10.83 | 27.08 | <0.0001 |
| Treatment | 43.33 | 4 | 10.83 | 27.05 | <0.0001 |
| Error | 4.00 | 10 | 0.40 | | |
| Total | 47.33 | 14 | | | |

Test: LSD Fisher Alpha = 0.05 DMS = 1.15061
Error: 0.4000 gl: 10

| | | | |
|---|---|---|---|
| Treatment | Mean | n | E.E. |

| | | | | | |
|---|---|---|---|---|---|
| Control | 5.00 | 3 | 0.37 | A | |
| Prome50SC2 | 1.33 | 3 | 0.37 | | B |
| Prome185ME2.5 | 1.00 | 3 | 0.37 | | B |
| Prome185ME3 | 0.67 | 3 | 0.37 | | B |
| Prome185ME3.5 | 0.33 | 3 | 0.37 | | B |

Means with a common letter are not significantly different (p>0.05)

Variable N R^{a} R^{a}Aj CV

### Eleu30 15 0.91 0.88 15.19

Table of Analysis of Variance (SC type III)

| F.V. | SC | gl | CK | F | p-value |
|---|---|---|---|---|---|
| Model | 35.07 | 4 | 8.77 | 26.30 | <0.0001 |
| Treatment | 35.07 | 4 | 8.77 | 26.30 | <0.0001 |
| Error | 3.33 | 10 | 0.33 | | |
| Total | 38.40 | 14 | | | |

Test: LSD Fisher Alpha = 0.05 DMS = 1.05035
Error: 0.3333 gl: 10

| Treatment | Mean | n | E.E. | | | |
|---|---|---|---|---|---|---|
| Control | 6.67 | 3 | 0.33 | A | | |
| Promel85ME2.5 | 4.00 | 3 | 0.33 | | B | |
| Prome50SC2 | 3.00 | 3 | 0.33 | | B | C |
| Promel85ME3 | 3.00 | 3 | 0.33 | | B | C |
| Promel85ME3.5 | 2.33 | 3 | 0.33 | | | C |

Means with a common letter are not significantly different (p>0.05)

### Var 2. Results for Emergences of Eleusine indica, Number of Seedlings/Meter2 Post-Treatment (Mean Absolute Values of Three Repetitions, 15 DDA and 30 DDA)

Variable N R^{a} R^{a} Aj CV

### Sorhriz15 15 0.91 0.87 51.35

Table of Analysis of Variance (SC type III)

| F.V. | SC | gl | CK | F | p-value |
|---|---|---|---|---|---|
| Model | 115.73 | 4 | 28.93 | 24.11 | <0.0001 |
| Treatment | 115.73 | 4 | 28.93 | 24.11 | <0.0001 |
| Error | 12.00 | 10 | 1.20 | | |
| Total | 127.73 | 14 | | | |

Test: LSD Fisher Alpha = 0.05 DMS = 1.99291
Error: 1.2000 gl: 10

| | | | |
|---|---|---|---|
| Treatment | Mean | n | E.E. |

| | | | | | |
|---|---|---|---|---|---|
| Control | 7.67 | 3 | 0.63 | A | |
| Prome50SC2 | 1.00 | 3 | 0.63 | | B |
| Prome185ME2.5 | 1.00 | 3 | 0.63 | | B |
| Prome185ME3 | 0.67 | 3 | 0.63 | | B |
| Prome185ME3.5 | 0.33 | 3 | 0.63 | | B |

Means with a common letter are not significantly different (p>0.05)

Variable N R^{a} R^{a} Aj CV

### Sorhriz30 15 0.94 0.91 30.36

Table of Analysis of Variance (SC type III)

| F.V. | SC | gl | CK | F | p-value |
|---|---|---|---|---|---|
| Model | 130.27 | 4 | 32.57 | 37.58 | <0.0001 |
| Treatment | 130.27 | 4 | 32.57 | 37.58 | <0.0001 |
| Error | 8.67 | 10 | 0.87 | | |
| Total | 138.93 | 14 | | | |

Test: LSD Fisher Alpha = 0.05 DMS = 1.69365
Error: 0.8667 gl: 10

| Treatment | Mean | n | E.E. | | | |
|---|---|---|---|---|---|---|
| Control | 8.67 | 3 | 0.54 | A | | |
| Prome185ME2.5 | 3.33 | 3 | 0.54 | | B | |
| Prome185ME3 | 1.67 | 3 | 0.54 | | B | C |
| Prome50SC2 | 1.00 | 3 | 0.54 | | | C |
| Prome185ME3.5 | 0.67 | 3 | 0.54 | | | C |

Means with a common letter are not significantly different (p>0.05)

### Var 3. Results for Emergences of Setaria sp., Number of Seedlings/Meter2 Post-Treatment (Mean Absolute Values of Three Repetitions, 15 DDA and 30 DDA)

Variable N R^{a} R^{a} Aj CV

### Sorhsem15 15 0.89 0.85 60.98

Table of Analysis of Variance (SC type III)

| F.V. | SC | gl | CK | F | p-value |
|---|---|---|---|---|---|
| Model | 67.73 | 4 | 16.93 | 21.17 | 0.0001 |
| Treatment | 67.73 | 4 | 16.93 | 21.17 | 0.0001 |
| Error | 8.00 | 10 | 0.80 | | |
| Total | 75.73 | 14 | | | |

Test: LSD Fisher Alpha = 0.05 DMS = 1.62720
Error: 0.8000 gl: 10

| | | | |
|---|---|---|---|
| Treatment | Mean | n | E.E. |

| | | | | | |
|---|---|---|---|---|---|
| Control | 5.67 | 3 | 0.52 | A | |
| Prome185ME2.5 | 1.00 | 3 | 0.52 | | B |
| Prome50SC2 | 0.33 | 3 | 0.52 | | B |
| Prome185ME3 | 0.33 | 3 | 0.52 | | B |
| Prome185ME3.5 | 0.00 | 3 | 0.52 | | B |

Means with a common letter are not significantly different (p>0.05)

Variable N R^{a} R^{a} Aj CV

### Sorhsem30 15 0.94 0.92 31.62

Table of Analysis of Variance (SC type III)

| F.V. | SC | gl | CK | F | p-value |
|---|---|---|---|---|---|
| Model | 62.00 | 4 | 15.50 | 38.75 | <0.0001 |
| Treatment | 62.00 | 4 | 15.50 | 38.75 | <0.0001 |
| Error | 4.00 | 10 | 0.40 | | |
| Total | 66.00 | 14 | | | |

Test: LSD Fisher Alpha = 0.05 DMS = 1.15061
Error: 0.4000 gl: 10

| | | | |
|---|---|---|---|
| Treatment | Mean | n | E.E. |

| | | | | | |
|---|---|---|---|---|---|
| Control | 6.00 | 3 | 0.37 | A | |
| Prome185ME2.5 | 1.67 | 3 | 0.37 | | B |
| Prome185ME3 | 1.00 | 3 | 0.37 | | B |
| Prome50SC2 | 0.67 | 3 | 0.37 | | B |
| Prome185ME3.5 | 0.67 | 3 | 0.37 | | B |

Means with a common letter are not significantly different (p>0.05)

### Var 4. Results for Emergences of Amaranthus quintensis, Number of Seedlings/Meter2 Post-Treatment (Mean Absolute Values of Three Repetitions, 15 DDA and 30 DDA)

General Comments:

The environmental conditions of good soil moisture caused weed species to appear in the control row in accordance with the expected, despite the prevailing low temperatures post-application of the treatments.

The product evaluated in this study presented an adequate performance compared to the chemical control, directly dependent on the test dose and the biological features of each weed species present.

Although the agronomic recommendation for this chemical molecule in its use for grass species in particular indicates the convenience of accompaniments at varying doses of acetochlor to make control more robust, its herbicidal ability in the present study was evidently shown and with statistical significance in most cases, on the species covered in this work.

### 4) Efficacy of the Herbicide Promethrin 18.5% ME for the Control of Weeds in a Sunflower Crop

Objective:

To determine the efficacy of the herbicide promethrin 18.5% ME for the control of broadleaf weeds in a sunflower crop.

Experimental Conditions:

TABLE 1
Information of the crop used to carry out the study.

| Locality | Crop | Variety | Date of sowing |
|---|---|---|---|
| Balcarce | Sunflower | ACA 203 CL | 17 Nov. 2017 |
| Cavanagh | Sunflower | ACA 203 CL | 9 Dec. 2017 |
| Margarita | Sunflower | ACA 203 CL | 20 Nov. 2017 |

Identification of pests to be controlled.

Table 2: Weed species evaluated

TABLE 2
Weed species evaluated

| | Weeds evaluated | |
|---|---|---|
| | (present in more | Other species present in the |
| Locality | than 70% of the plots) | weed community |
| Balcarce | Portulaca oleracea | Cyperus rotundus, Digitaria |
| | (nv: verdolaga) | sanguinalis, Sonchus |
| | | oleraceus, Conyza |
| | | bonariensis, Polygonum |
| | | aviculare, Chenopodium album |
| Cavanagh | Euphorbia serpeas | Conyza bonariensis, |
| | (nv: yerba meona) | Amaranthus hybridus, Eleusine |
| | Oxalis corniculata | indica, Gamochaeta spicata, |
| | (nv: vinagrillo) | Lamium amplexicaule, |
| | Cyperus rotundas | Portulaca oleracea |
| | (nv: green onion) | |
| Margarita | Amaranthus hybridus | Eleusine indica, Echinochloa |
| | (nv: yuyo colorado) | crusgalli, Ipomoea purpurea, |
| | Sonchus oleraceus | Conyza bonariensis, Chloris |
| | (nv: sow thistle) | spp., Sorghum halepense |
| | Ipomea grandifolia | Gamochaeta spicata, Lamium |
| | (nv: climbing plant) | amplexicaule |

Weeds evaluated (present in more than 70% of the plots) Other species present in the weed community

Geographical locality and agro-ecological features.

TABLE 3
Geographical locality of trials.

| Locality | Province | Test GPS |
|---|---|---|
| Balcarce | Buenos Aires | 37° 53′47.5″ S; 58° 18′39.7″O |
| Cavanagh | Córdoba | 33°27′50.53″S; 62°19′43.70″O |
| Margarita | Santa Fe | 29°42′26.67″S; 60° 8′28.69″O |

### Soil and Meteorological Data

FIG. 8 shows 3 graphics of Temperature and Rainfall in months from November 2017 to January 2018 in trial sites as Balcarce, Cavanagh and Margarita.

TABLE 4
soil characteristics

| | | | | | | | Cations and exchange capacity | | | | |
|---|---|---|---|---|---|---|---|---|---|---|---|
| | Depth | | CE | P | MO | N—NO3 | (cmolc/kg) | | | | |
| Locality | (cm) | pH | (d5/m) | (ppm) | % | (ppm) | Ca | Mg | K | Na | CIC |
| Balcarce | 0-20 | 5.80 | — | 32.2 | 4.7 | 13.5 | — | — | — | — | — |
| Cavanagh | 0-30 | 2.89 | 0.08 | 30.3 | 2.63 | 17.0 | 10.20 | 2.24 | 1.48 | 0.07 | 15.4 |
| Margartia | 0-20 | 6.49 | 0.37 | 10.3 | 2.13 | 7.7 | 8.69 | 1.71 | 0.56 | 0.21 | 13.36 |

Experimental Design:

In a randomized complete block design with four replications, plots three meters wide by seven meters long were marked with matched controls of one meter and the treatments described below were applied:

TABLE 5
Description of treatments being evaluated

| Treatment | Products | Abbreviation | cc/ha |
|---|---|---|---|
| 1 | Control | Control | — |
| 2 | Promethrin 18.5% ME | EC (2500) | 2500 |
| 3 | Promethrin 18.5% ME | EC (3000) | 3000 |
| 4 | Promethrin 18.5% ME | EC (3500) | 3500 |
| 5 | Promethrin 50% SC | TQCO | 2000 |
| Chemical | | | |
| control | | | |

### Application:

Form of Application

Herbicides being evaluated were sprayed on a complete coverage basis using an application volume of 120 l ha⁻¹. To this end, a CO₂ spraying backpack and four TTI 110-015 flat fan tablets were provided. In all cases the working pressure was 2 bar and the distance between peaks was 0.52 m. No unusual weather events occurred that may have had an impact on the study quality.

TABLE 6
Weather information corresponding to the day of application

| | Balcarce | Cavanagh | Margarita |
|---|---|---|---|
| Date of application | 17 Nov. 2017 | 9 Nov. 2017 | 23 Oct. 2017 |
| Wind (Km/h) | 5 | 5.3 | 5.5 |
| Direction of the wind | NW | SW | N |
| Temperature (° C.) | 21.4 | 29.1 | 20.3 |
| Relative humidity {%) | 54.7 | 25 | 54 |

Evaluation, Data and Measurements Recording:

Method, timing and frequency of evaluation

Phytotoxicity:

At 15, 30 and 45 DDA, the phytotoxicity generated by the herbicides on the sunflower crop was evaluated visually and with a percentage scale from 0% to 100%.

TABLE 7
Detail of symptomatology used for evaluating phytotoxicity

| Category | Range | Description |
|---|---|---|
| No | 0 | No effect, appearance similar to wheat |
| damage | | |
| Slight | 10 | only visible with matched control |
| damage | 20 | Slightly visible without matched |
| | | control, with no impact on yield |
| | 30 | Clearly identifiable symptoms, with no |
| | | impact on yield |
| | 40 | Very noticeable symptoms, the crop |
| | | recovers, but may have losses in yield |
| Moderate | 50 | Medium damage, crop recovers, likely |
| damage | | impact on yield |
| | 60 | Medium to severe damage, loss of |
| | | complete plants, effectively affecting |
| | | yield. |
| | 70 | Severe damage, significant loss of |
| | | plants, significant decrease in yield |
| Severe | 80 | Significant plant death, less than 50% |
| damage | | of remaining plants with marked |
| | | symptoms. |
| | 90 | Less than 30% of remaining plants, the |
| | | rest with severe symptoms of |
| | | phytotoxicity |
| Total | 100 | Complete destruction of the crop |
| death | | |

Efficacy:

The control efficacy of treatments on weeds present at 15, 30 and 45 days after application (DDA) was evaluated. The control percentage of the herbicides was determined considering the seedlings emerged in the plot with respect to the seedlings emerged in the matched control.

Statistical Analysis:

Analysis of variance (ANOVA) was carried out using treatments and replicates of the test as classification variables, and the control exercised on weeds as a dependent variable. The means were compared using the Fisher test for p<0.05. The statistical program used was InfoStat (2016).

Results:

Balcarce

TABLE 9
Control exerted by the 18.5% ME herbicide on weeds present
in a sunflower crop in the town of Balcarce (Buenos Aires).

| | | | | |
|---|---|---|---|---|
| DDA | Treatment | Mean ± EE | LSD Fisher *¹ | p-value |

Portulaca oleracea

| | | | | |
|---|---|---|---|---|
| 15 | Control | 0.0 ± 0.0 | c | <0.0001 |
| | ME (2000) | 80.0 ± 11.6 | b | |
| | ME (2500) | 97.5 ± 2.5 | a | |
| | ME (3000) | 100.0 ± 0.0 | a | |
| | TQCO | 100.0 ± 0.0 | a | |
| 30 | Control | 0.0 ± 0.0 | c | <0.0001 |
| | ME (2000) | 75.0 ± 11.9 | b | |
| | ME (2500) | 86.3 ± 3.2 | ab | |
| | ME (3000) | 93.8 + 2.4 | a | |
| | TQCO | 97.5 ± 2.5 | a | |
| 45 | Control | 0.0 ± 0.0 | c | <0.0001 |
| | ME (2000) | 74.8 ± 11.7 | b | |
| | ME (2500) | 82.5 ± 1.4 | ab | |
| | ME (3000) | 93.8 ± 2.0 | a | |
| | TQCO | 96.8 ± 2.4 | a | |

*¹ Mean comparison test

### Final Report of Results:

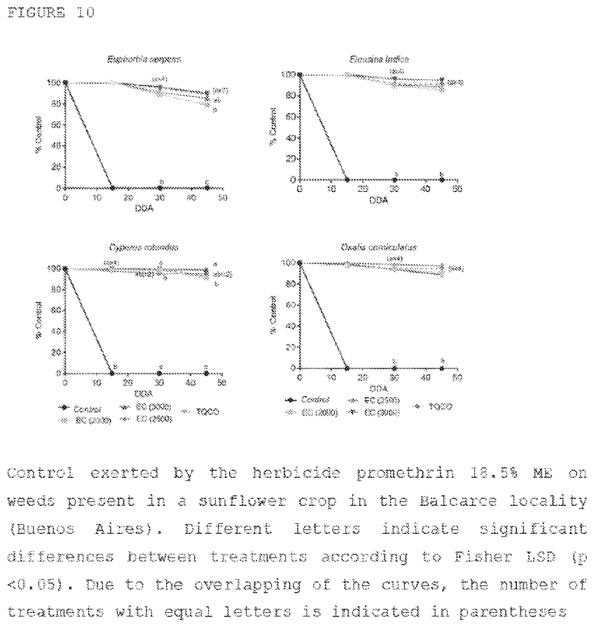

FIG. 9 shows the control exerted by the herbicide promethrin 18.5% ME on weeds present in a sunflower crop in the Balcarce locality (Buenos Aires). Different letters indicate significant differences between treatments according to Fisher LSD (p<0.05). Due to the overlapping of the curves, the number of treatments with equal letters is indicated in parentheses.

Conclusion:
The herbicides being studied did not cause damage to the sunflower hybrid used in the present test.
The herbicide promethrin 18.5% ME applied at a rate of 3000 ml ha⁻¹ controlled Portulaca oleracea by more than 90% at 45 DDA and did not statistically differ from the control achieved by the chemical control.
The control recorded for the mean dose of the herbicide promethrin 18.5% ME (2500 ml ha⁻¹) did not statistically differ from that achieved by the chemical control and ME (3000) until 30 DDA.
The lowest of the doses being studied of promethrin 18.5% ME controlled P. oleracea by more than 70% at 45 DDA. and it did not statistically differ from the control achieved by the average dose of the same herbicide.

### Cavanagh

TABLE 10
Control exerted by the herbicide promethrin 18.5% ME on weeds present
in a sunflower crop in the town of Cavanagh (Córdoba)

| | | | | |
|---|---|---|---|---|
| DDA | Treatment | Mean ± EE | LSD Fisher*¹ | p-value |

Cyperus esculentus

| | | | | |
|---|---|---|---|---|
| 15 | Control | 0.0 ± 0.0 | b | <0.0001 |
| | ME (2000) | 98.8 ± 1.3 | a | |
| | ME (2500) | 97.5 + 2.5 | a | |
| | ME (3000) | 100.0 ± 0.0 | a | |
| | TQCO | 100.0 ± 0.0 | a | |
| 30 | Control | 0.0 ± 0.0 | c | <0.0001 |
| | ME (2000) | 98.5 ± 1.2 | ab | |
| | ME (2500) | 95.0 ± 2.9 | b | |
| | ME (3000) | 98.8 ± 1.3 | ab | |
| | TQCO | 100.0 ± 0.0 | a | |
| 45 | Control | 0.0 ± 0.0 | c | <0.0001 |
| | ME (2000) | 91.3 ± 1.3 | b | |
| | ME (2500) | 95.0 ± 2.9 | ab | |
| | ME (3000) | 98.8 ± 1.3 | a | |
| | TQCO | 92.5 ± 4.8 | ab | |

Eleusine indica

| | | | | |
|---|---|---|---|---|
| 15 | Control | 0.0 ± 0.0 | — | — |
| | ME (2000) | 100.0 ± 0.0 | — | |
| | ME (2500) | 100.0 ± 0.0 | — | |
| | ME (3000) | 100.0 ± 0.0 | — | |
| | TQCO | 100.0 ± 0.0 | — | |
| 30 | Control | 0.0 ± 0.0 | b | <0.0001 |
| | ME (2000) | 89.8 ± 4.4 | a | |
| | ME (2500) | 90.0 ± 4.6 | a | |
| | ME (3000) | 96.0 ± 1.0 | a | |
| | TQCO | 91.3 ± 3.8 | a | |
| 45 | Control | 0.0 ± 0.0 | b | <0.0001 |
| | ME (2000) | 86.0 ± 6.7 | a | |
| | ME (2500) | 88.8 ± 3.3 | a | |
| | ME (3000) | 94.8 ± 1.8 | a | |
| | TQCO | 91.3 + 3.8 | a | |

Euphorbia serpens

| | | | | |
|---|---|---|---|---|
| 15 | Control | 0.0 ± 0.0 | — | — |
| | ME (2000) | 100.0 ± 0.0 | — | |
| | ME (2500) | 100.0 ± 0.0 | — | |
| | ME (3000) | 100.0 ± 0.0 | — | |
| | TQCO | 100.0 ± 0.0 | — | |
| 30 | Control | 0.0 ± 0.0 | b | <0.0001 |
| | ME (2000) | 88.8 ± 6.6 | a | |
| | ME (2500) | 91.0 ± 4.1 | a | |
| | ME (3000) | 96.0 ± 2.3 | a | |
| | TQCO | 95.0 ± 2.0 | a | |
| 45 | Control | 0.0 ± 0.0 | c | <0.0001 |
| | ME (2000) | 78.8 ± 3.2 | b | |
| | ME (2500) | 85.0 ± 2.0 | ab | |
| | ME (3000) | 90.0 ± 2.0 | a | |
| | TQCO | 88.8 ± 1.3 | a | |

Oxalis corniculatus

| | | | | |
|---|---|---|---|---|
| 15 | Control | 0.0 ± 0.0 | b | <0.0001 |
| | ME (2000) | 97.5 ± 2.5 | a | |
| | ME (2500) | 100.0 ± 0.0 | a | |
| | ME (3000) | 98.8 ± 1.3 | a | |
| | TQCO | 98.8 ± 1.3 | a | |
| 30 | Control | 0.0 ± 0.0 | b | <0.0001 |
| | ME (2000) | 94.8 ± 4.9 | a | |
| | ME (2500) | 98.5 ± 1.2 | a | |
| | ME (3000) | 93.8 ± 4.7 | a | |
| | TQCO | 94.8 ± 4.9 | a | |
| 45 | Control | 0.0 ± 0.0 | b | <0.0001 |
| | ME (2000) | 90.0 ± 5.4 | a | |
| | ME (2500) | 97.3 ± 2.4 | a | |
| | ME (3000) | 88.8 ± 6.6 | a | |
| | TQCO | 94.8 ± 4.9 | a | |

*¹Mean comparison test

### Report of Results:

FIG. 10 shows the control exerted by the herbicide promethrin 18.5% ME on weeds present in a sunflower crop in the Balcarce locality (Buenos Aires). Different letters indicate significant differences between treatments according to Fisher LSD (p<0.05). Due to the overlapping of the curves, the number of treatments with equal letters is indicated in parentheses.

Conclusion:
The herbicides being studied did not cause damage to the sunflower hybrid used in the present test.
The herbicide promethrin 18.5% ME controlled the weeds Cyperus esculentus, Eleusine indica, Euphorbia serpens and Oxalis corniculatus by more than 85% at 30 DDA.
No significant differences were found between the control achieved by the chemical control and the medium and high dose of promethrin 18.5% ME at 45 DDA.
The lowest of the doses being studied of promethrin 18.5% ME (2000 ml ha⁻¹) controlled the weeds present by more than 75%. It only differed from the chemical control for the E. serpens control, wherein the control was 10% lower at 45 DDA.

Margarita

TABLE 11
Control exerted by the herbicide promethrin 18.5% ME on weeds
present in a sunflower crop in the town of Margarita (Santa Fe)

| | | | | |
|---|---|---|---|---|
| DDA | Treatment | Mean ± EE | LSD Fisher*¹ | p-valor |

Amaranthus hybridus and Sonchus oleraceus

| | | | | |
|---|---|---|---|---|
| 15 | Control | 0.0 ± 0.0 | — | — |
| | ME (2000) | 100.0 ± 0.0 | — | |
| | ME (2500) | 100.0 ± 0.0 | — | |
| | ME (3000) | 100.0 ± 0.0 | — | |
| | TQCO | 100.0 ± 0.0 | — | |
| 30 | Control | 0.0 ± 0.0 | c | <0.0001 |
| | ME (2000) | 80.0 ± 4.1 | b | |
| | ME (2500) | 87.5 ± 4.8 | ab | |
| | ME (3000) | 95.5 ± 2.9 | a | |
| | TQCO | 95.0 ± 5.0 | a | |
| 45 | Control | 0.0 ± 0.0 | c | <0.0001 |
| | ME (2000) | 65.0 ± 10.4 | b | |
| | ME (2500) | 78.8 ± 6.6 | ab | |
| | ME (3000) | 81.3 ± 3.2 | ab | |
| | TQCO | 92.5 ± 7.5 | a | |

Ipomea grandifolia

| | | | | |
|---|---|---|---|---|
| 15 | Control | 0.0 ± 0.0 | — | — |
| | ME (2000) | 100.0 ± 0.0 | — | |
| | ME (2500) | 100.0 ± 0.0 | — | |
| | ME (3000) | 100.0 ± 0.0 | — | |
| | TQCO | 100.0 ± 0.0 | — | |
| 30 | Control | 0.0 ± 0.0 | b | <0.0001 |
| | ME (2000) | 63.8 ± 6.3 | a | |
| | ME (2500) | 65.0 ± 4.6 | a | |
| | ME (3000) | 61.3 ± 10.9 | a | |
| | TQCO | 47.5 ± 11.8 | a | |
| 45 | Control | 0.0 ± 0.0 | b | <0.0001 |
| | ME (2000) | 47.5 ± 6.3 | a | |
| | ME (2500) | 40.0 ± 4.1 | a | |
| | ME (3000) | 45.0 ± 9.6 | a | |
| | TQCO | 33.8 ± 8.0 | a | |

*¹Mean comparison test

FIG. 11 shows the control exerted by the herbicide promethrin 18.5% ME on weeds present in a sunflower crop in the Balcarce locality (Buenos Aires). Different letters indicate significant differences between treatments according to Fisher LSD (p<0.05). Due to the overlapping of the curves, the number of treatments with equal letters is indicated in parentheses.

### Conclusion:

The herbicides being studied did not cause damage to the sunflower hybrid used in the present trial.
The weed Ipomoea grandiflora was poorly controlled by the herbicides being studied, the control being less than 50% at 45 DDA.
The herbicide promethrin 18.5% ME controlled the weeds Amaranthus hybridus and Sunchus oleraceus by up to 81% at 45 DDA. The lowest of the doses being studied controlled these weeds by 80% at 30 DDA and said control decreased to 65% 15 days later.
No statistically significant differences were found between the doses of promethrin 18.5% ME studied for the control of A. hybridus and S. oleraceus.

### 5) Efficacy of the Herbicide Promethrin 18.5% ME for the Control of Weeds in a Sunflower Crop

Localities:

Balcarce, Buenos Aires, Argentina.

Cavanagh, Córdoba, Argentina.

Margarita, Santa Fe, Argentina.

Objective:

To determine the efficacy of the herbicide promethrin 18.5% ME for the control of weeds in the sunflower crop.

Experimental Conditions:

TABLE 1
Information of the crop used to carry out the study

| Locality | Crop | Variety | Date of sowing |
|---|---|---|---|
| Balcarce | Sunflower | ACA 203 CL | 1 Nov. 2018 |
| Cavanagh | Sunflower | ACA 203 CL | 23 Nov. 2018 |
| Margarita | Sunflower | ACA 203 CL | 5 Nov. 2018 |

### Identification of Pests to be Controlled:

TABLE 2
Weed species evaluated

| | Weeds evaluated | |
|---|---|---|
| | (present in more | Other species present in the |
| Locality | than 70% of the plots) | weed community |
| Balcarce | Portulaca oleracea | Chenopodium album, Brassica |
| | (nv: verdolaga) | napus, Polygonum aviculare, |
| | | Viola avenis, Conyza |
| | | bonariensis, Carduus nutans, |
| | | Digitaria sanguinalis, |
| | | Cyperus esculentus |
| Cavanagh | Amarantlms hybridus | Conyza bonariensis, |
| | (nv: yuyo Colorado) | Echinochloa crus-galli, |
| | Portulaca oleracea | Gamochaeta spicata, Lamium |
| | (nv: verdolaga) | amplexicaule, Gamochaeta |
| | | spicata, Eulisine indica |
| Margarita | Amaranthus hybridus | Conyza bonariensis, Portulaca |
| | (nv: yuyo Colorado) | oleracea, Catula australis, |
| | | Lamium amplexicaule, |
| | | Gamochaeta spicata |

### Geographical Locality and Agro-Ecological Features:

TABLE 3
Geographical locality of the trials

| Locality | Province | Test DPS |
|---|---|---|
| Balcarce | Vuenos Aires | 37° 53′46.5″ S; 58° 18′42.1″ O |
| Cavanagh | Córdoba | 33°27′51.20″S; 62°19′43.20″O |
| Margarita | Santa Fe | 29°43′22.60″S; 60° 8′26.30″O |

### Soil and Meteorological Data:

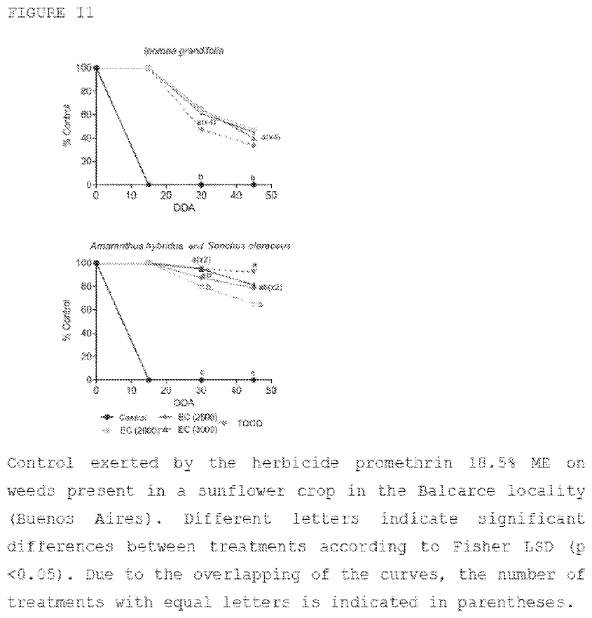

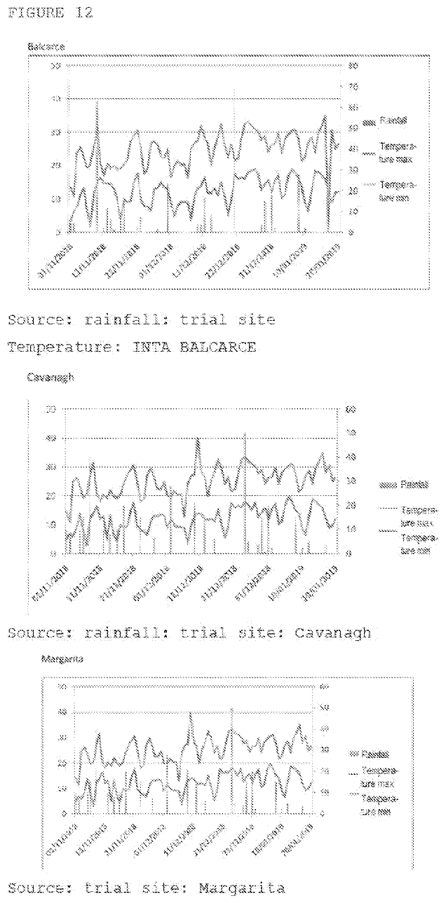

The meteorological data in Balcarce, Cavanagh and Margarita from November 2018 to January 2019 is showed in FIG. 12.

TABLE 4
soil characteristics

| | | | | | | | Cations and exchange capacity | | | | |
|---|---|---|---|---|---|---|---|---|---|---|---|
| | Depth | | CE | P | MO | N—NO3 | (cmolc/kg) | | | | |
| Locality | (cm) | pH | (d5/m) | (ppm) | % | (ppm) | Ca | Mg | K | Na | CIC |
| Balcarce | 0-20 | 5.80 | — | 32.2 | 4.7 | 13.5 | — | — | — | — | — |
| Cavanagh | 0-30 | 5.89 | 0.08 | 30.3 | 2.63 | 17.0 | 10.20 | 2.24 | 1.48 | 0.07 | 15.4 |
| Margarita | 0-20 | 6.49 | 0.37 | 10.3 | 2.13 | 7.7 | 8.69 | 1.71 | 0.56 | 0.21 | 13.36 |

Design of the Experiment/Size of the Plot/Number of Repetitions/Choice of Treatments

In a randomized complete block design with four replications, the present trial was carried out on plots three meter wide by seven meter long, with matched controls of one meter.

TABLE 5
Description of treatments being evaluated

| Treatment | Products | Abbreviation | cc/ha |
|---|---|---|---|
| 1 | Control | Control | — |
| 2 | Promethrin 18.5% ME | ME (2500) | 2500 |
| 3 | Promethrin 18.5% ME | ME (3000) | 3000 |
| 4 | Promethrin 18.5% ME | ME (3500) | 3500 |
| 5 | Promethrin 50% SC | TQCO | 2000 |
| Chemical | | | |
| control | | | |

Application Data:

Form of Application:

The evaluated herbicides were sprayed on a complete coverage basis using an application volume of 110 l ha⁻¹. To this end, a CO₂ spraying backpack and four TTI 110-015 flat fan tablets were provided. In all cases the working pressure was 2 bar and the distance between peaks was 0.52 m. No unusual weather events occurred that may have had an impact on the study quality.

TABLE 6
Weather information corresponding to the day of application

| | Balcarce | Cavanagh | Margarita |
|---|---|---|---|
| Date of application | 2 Nov. 2018 | 24 Nov. 2018 | 5 Nov. 2018 |
| Wind (Km/h) | 3.2 | 2.9 | 7.5 |
| Direction of the wind | NO | SE | N |
| Temperature (° C.) | 24.5 | 22.3 | 25 |
| Relative humidity (%) | 38 | 45.3 | 63.5 |

Evaluation, Data and Measurements Recording:

Method, Timing and Frequency of Evaluation

Phytotoxicity

At 15, 30 and 45 days after application (DDA), the phytotoxicity generated by herbicides on the sunflower crop was evaluated visually and with a percentage scale from 0% to 100%.

TABLE 7
Detail of symptomatology used for evaluating phytotoxicity

| Category | Range | Description |
|---|---|---|
| No | 0 | No effect, appearance similar to control |
| damage | 10 | only visible with matched control |
| Slight | 20 | Slightly visible without matched |
| damage | | control, with no impact on yield |
| | 30 | Clearly identifiable symptoms, with no |
| | | impact on yield |
| | 40 | Very noticeable symptoms, the crop |
| | | recovers, but may have losses in yield |
| Moderate | 50 | Medium damage, crop recovers, likely |
| damage | | impact on yield |
| | 60 | Medium to severe damage, loss of |
| | | complete plants, effectively affecting |
| | | yield. |
| | 70 | Severe damage, significant loss of |
| | | plants, significant decrease in yield |
| Severe | 80 | Significant plant death, less than 50% |
| damage | | of remaining plants with marked |
| | | symptoms. |
| | 90 | Less than 30% of remaining plants, the |
| | | rest with severe symptoms of |
| | | phytotoxicity |
| Total | 100 | Complete destruction of the crop |
| death | | |

Efficacy:

The efficacy of control of the treatments on the weeds present at 15, 30 and 45 days after application (DDA) was evaluated. To this end, the present symptomatology on weeds was considered (Table 8).

TABLE 8
Detail of the symptoms used to assess herbicide control.

| Control/damage | |
|---|---|
| (%) | Detail |
| 0 | No control: no symptoms |
| 10-20 | Very poor control: very mild symptoms, |
| | stunted growth |
| 20-30 | Poor control: overt chlorosis, growth |
| | arrest |
| 30-50 | Poor control: very obvious symptoms. |
| | Persistent chlorosis. Incipient necrosis. |
| 50-70 | Moderate control: up to 20% of necrosis in |
| | plants |
| 70-80 | Acceptable control: up to 40% necrosis in |
| | large plants |
| 80-90 | Good to very good control: 75-90% of |
| | individuals with necrosis throughout the |
| | plant |
| 90-100 | Excellent to total control: 90-100% of |
| | individuals with necrosis throughout the |
| | plant |

Statistical Analysis:

Analysis of variance (ANOVA) was performed using the treatments and replicates of the test as classification variables. The means were compared using the Fisher test for p<0.05. The statistical program used was InfoStat (2016).

Results:

Balcarce

TABLE 9
Control exerted by the 18.5% ME herbicide on weeds present
in a sunflower crop in the town of Balcarce (Buenos Aires).

| | | | | |
|---|---|---|---|---|
| DDA | Treatment | Mean ± EE | LSD Fisher *¹ | p-value |

Portulaca oleracea

| | | | | |
|---|---|---|---|---|
| 15 | Control | 0.0 ± 0.0 | c | <0.0001 |
| | ME (2000) | 80.0 ± 11.6 | b | |
| | ME (2500) | 97.5 + 2.5 | a | |
| | ME (3000) | 100.0 ± 0.0 | a | |
| | TQCO | 100.0 ± 0.0 | a | |
| 30 | Control | 0.0 ± 0.0 | c | <0.0001 |
| | ME (2000) | 75.0 ± 11.9 | b | |
| | ME (2500) | 86.3 ± 3.2 | ab | |
| | ME (3000) | 93.8 ± 2.4 | a | |
| | TQCO | 97.5 ± 2.5 | a | |
| 45 | Control | 0.0 ± 0.0 | c | <0.0001 |
| | ME (2000) | 74.8 ± 11.7 | b | |
| | ME (2500) | 82.5 ± 1.4 | ab | |
| | ME (3000) | 93.8 ± 2.0 | a | |
| | TQCO | 96.8 ± 2.4 | a | |

*¹ Mean comparison test

Conclusions:
The herbicides being studied did not cause damage to the sunflower variety used in the present trial.
The TQCO controlled Portulaca oleracea in advance with respect to the evaluated doses of Promethrin 18.5% ME.
Promethrin 18.5% ME had excellent control 90%) of P. oleracea at 30 and 45 DDA.
No statistically significant differences were found between the doses of ME (3000), ME (3500) and TQCO for the control of P. oleracea at 30 and 45 DDA

### Cavanagh

TABLE 10
Control exerted by the herbicide promethrin 18.5% ME on weeds present
in a sunflower crop in the town of Cavanagh (Córdoba)

| | | | | |
|---|---|---|---|---|
| DDA | Treatment | Mean ± EE | LSD Fisher*¹ | p-value |

Portulaca oleracea

| | | | | |
|---|---|---|---|---|
| 15 | Control | 0.0 ± 1.19 | a | <0.0001 |
| | ME (2500) | 76.7 ± 1.19 | b | |
| | ME (3000) | 77.5 ± 1.19 | b | |
| | ME (3500) | 84.2 ± 1.19 | c | |
| | TQCG | 84.7 ± 1.19 | c | |
| SO | T estigo | 0.0 + 1.11 | a | <0.0001 |
| | ME (2500) | 71.2 + 1.11 | b | |
| | ME (3000) | 90.0 ± 1.11 | c | |
| | ME (3500) | 93.0 ± 1.11 | td | |
| | TQCO | 96.2 ± 1.11 | d | |
| 45 | T estigo | 0.0 ± 1.36 | a | <0.0001 |
| | ME (2500) | 73.0 ± 1.36 | b | |
| | ME (3000) | 86.2 ± 1.36 | be | |
| | ME (3500) | 95.0 ± 1.36 | cd | |
| | TQCO | 96.2 ± 1.36 | d | |

Amaranthus hibridus

| | | | | |
|---|---|---|---|---|
| 15 | Control | 0.0 ± 1.63 | a | <0.0001 |
| | ME (2500) | 81.7 ± 1.63 | b | |
| | ME (3000) | 83.7 ± 1.63 | be | |
| | ME (3500) | 88.7 ± 1.63 | cd | |
| | TQCO | 89.7 ± 1.63 | d | |
| 30 | Control | 0.0 ± 1.11 | a | <0.0001 |
| | ME (2500) | 81.2 ± 1.11 | b | |
| | ME (3000) | 87.5 ± 1.11 | c | |
| | ME (3500) | 90.5 ± 1.11 | cd | |
| | TQCO | 91.2 ± 1.11 | d | |
| 45 | Control | 0.0 ± 1.26 | a | <0.0001 |
| | ME (2500) | 82.5 ± 1.26 | b | |
| | ME (3000) | 87.5 ± 1.26 | c | |
| | ME (3500) | 92.5 ± 1.26 | d | |
| | TQCO | 94.2 ± 1.26 | d | |

*¹Mean comparison test

Conclusions:
The herbicides studied did not cause damage to the sunflower variety used in the present trial.
TQCO and ME (3500) controlled Portulaca oleracea and Amaranthus hibridus in advance.
No statistically significant differences were found between the ME (3500) and TQCO doses for the control of P. oleracea and Amaranthus hibridus at 15, 30 and 45 DDA, with all the controls above 80%, as well as ME (3000), but with statistically significant differences.

Margarita

TABLE 11
Control exerted by the herbicide promethrin 18.5% ME on weeds
present in a sunflower crop in the town of Margarita (Santa Fe)

| | | | | |
|---|---|---|---|---|
| DDA | Treatment | Mean ± EE | LSD Fisher *¹ | p-value |

Amaranthus hibridus

| | | | | |
|---|---|---|---|---|
| 15 | Control | 0.0 + 2.19 | a | <0.0001 |
| | ME (2500) | 67.5 ± 2.19 | b | |
| | ME (3000) | 80.0 ± 2.19 | c | |
| | ME (3500) | 85.0 ± 2.19 | cd | |
| | TQCO | 87.5 ± 2.19 | d | |
| 30 | Control | 0.0 ± 2.36 | a | <0.0001 |
| | ME (2500) | 70.0 ± 2.36 | b | |
| | ME (3000) | 88.7 ± 2.36 | c | |
| | ME (3500) | 90.0 ± 2.36 | c | |
| | TQCO | 91.2 ± 2.36 | c | |
| 45 | Control | 0.0 ± 1.36 | a | <0.0001 |
| | ME (2500) | 63.7 ± 1.36 | b | |
| | ME (3000) | 82.5 ± 1.36 | c | |
| | ME (3500) | 87.5 ± 1.36 | c | |
| | TQCO | 96.2 ± 1.36 | d | |

*¹ Mean comparison test

Conclusions:
The herbicides being studied did not cause damage to the sunflower variety used in the present trial.
TQCO and ME (3500) controlled Amaranthus hibridus in advance.
Statistically significant differences were found between the ME (3500) and TQCO doses for the control of Amaranthus hibridus at 45 DDA. Likewise, the ME (3000) controls and ME (3500) controls were above 80%.

### Statistical Analysis:

### Balcarce

Analysis of Variance

| Variable | N | R^{a} | R^{a}Aj | CV |
|---|---|---|---|---|
| Portulaca oleracea | 20 | 0.99 | 0.98 | 7.63 |

Table of Analysis of Variance (SC type III)

| F.V. | SC | gl | CM | F | p-value |
|---|---|---|---|---|---|
| Model | 7988.75 | 7 | 1141.25 | 130.43 | <0.0001 |
| Treatment | 7975.00 | 4 | 1993.75 | 227.86 | <0.0001 |
| Replication | 13.75 | 3 | 4.58 | 0.52 | 0.6741 |
| Error | 105.00 | 12 | 8.75 | | |
| Total | 8093.75 | 19 | | | |

Test: LSD Fisher Alpha = 0.05 DMS = 4.55731
Error: 8.7500 gl: 12

| Treatment | Mean | n | E.E. | | | |
|---|---|---|---|---|---|---|
| 1 | 0.00 | 4 | 1.48A | | | |
| 2 | 40.00 | 4 | 1.48 | B | | |
| 5 | 48.75 | 4 | 1.48 | | C | |
| 3 | 50.00 | 4 | 1.48 | | C | |
| 4 | 55.00 | 4 | 1.48 | | | D |

Analysis of Variance

| Variable | N | R^{a} | R^{a}Aj | CV |
|---|---|---|---|---|
| Portulaca oleracea | 20 | 1.00 | 1.00 | 3.38 |

Table of Analysis of Variance [SC type 111)

| F.V. | SC | gl | CM | F | p-value |
|---|---|---|---|---|---|
| Model | 28553.10 | 7 | 4079.01 | 638.18 | <0.0001 |
| Treatment | 28471.30 | 4 | 7117.83 | 1113.61 | <0.0001 |
| Replication | 81.80 | 3 | 27.27 | 4.27 | 0.0288 |
| Error | 76.70 | 12 | 6.39 | | |
| Total | 28629.80 | 19 | | | |

Test: LSD Fisher Alpha = 0.05 DMS = 3.89504
Error: 6.3917 gl: 12

| Treatment | Mean | n | E.E. | | | |
|---|---|---|---|---|---|---|
| 1 | 0.00 | 4 | 1.26 | A | | |
| 2 | 85.00 | 4 | 1.26 | | B | |
| 3 | 94.75 | 4 | 1.26 | | | C |
| 4 | 96.50 | 4 | 1.26 | | | C |
| 5 | 98.25 | 4 | 1.26 | | | C |

Analysis of Variance

| Variable | N | R^{a} | R^{a}Aj | CV |
|---|---|---|---|---|
| Portulaca oleracea | 20 | 1.00 | 1.00 | 3.30 |

Table of Analysis of Variance (SC type III)

| F.V. | SC | gl | CM | F | p-value |
|---|---|---|---|---|---|
| Model | 28956.85 | 7 | 4136.69 | 662.75 | <0.0001 |
| Treatment | 28907.50 | 4 | 7226.88 | 1157.84 | <0.0001 |
| Replication | 49.35 | 3 | 16.45 | 2.64 | 0.0976 |
| Error | 74.90 | 12 | 6.24 | | |
| Total | 29031.75 | 19 | | | |

Test: LSD Fisher Alpha = 0.05 DMS = 3.84906
Error: 6.2417 gl: 12

| Treatment | Mean | n | E.E. | | | |
|---|---|---|---|---|---|---|
| 1 | 0.00 | 4 | 1.25 | A | | |
| 2 | 88.75 | 4 | 1.25 | | B | |
| 3 | 95.00 | 4 | 1.25 | | | C |
| 4 | 96.25 | 4 | 1.25 | | | C |
| 5 | 98.75 | 4 | 1.25 | | | C |

Analysis of Variance

| Variable | N | R^{a} | R^{a}Aj | CV |
|---|---|---|---|---|
| Portulaca oleracea | 20 | 1.00 | 0.99 | 3.68 |

Table of Analysis of Variance (SC type III)

| F.V. | SC | gl | CM | F | p-value |
|---|---|---|---|---|---|
| Model | 21230.65 | 7 | 3032.93 | 536.01 | <0.0001 |
| Treatment | 21117.30 | 4 | 5279.33 | 933.02 | <0.0001 |
| Replication | 113.35 | 3 | 37.78 | 6.68 | 0.0067 |
| Error | 67.90 | 12 | 5.66 | | |
| Total | 21298.55 | 19 | | | |

Test: LSD Fisher Alpha = 0.05 DMS = 3.66479
Error: 5.6583 gl: 12

| Treatment | Mean | n | E.E. | | | |
|---|---|---|---|---|---|---|
| 1 | 0.00 | 4 | 1.19 | A | | |
| 2 | 76.75 | 4 | 1.19 | | B | |
| 3 | 77.50 | 4 | 1.19 | | B | |
| 4 | 84.25 | 4 | 1.19 | | | C |
| 5 | 84.75 | 4 | 1.19 | | | C |

Analysis of Variance

| Variable | N | R^{a} | R^{a}Aj | CV |
|---|---|---|---|---|
| Portulaca oleracea | 20 | 1.00 | 1.00 | 3.16 |

| F.V. | SC | gl | CM | F | p-value |
|---|---|---|---|---|---|
| Model | 26174.90 | 7 | 3739.27 | 761.82 | <0.0001 |
| Treatment | 26078.30 | 4 | 6519.58 | 1328.27 | <0.0001 |
| Replication | 96.60 | 3 | 32.20 | 6.56 | 0.0071 |
| Error | 58.90 | 12 | 4.91 | | |
| Total | 26233.80 | 19 | | | |

Test: LSD Fisher Alpha = 0.05 DMS = 3.41328
Error: 4.9083 gl: 12

| | | | |
|---|---|---|---|
| Treatment | Mean | n | E.E. |

| | | | | | | | |
|---|---|---|---|---|---|---|---|
| 1 | 0.00 | 4 | 1.11 | A | | | |
| 2 | 71.25 | 4 | 1.11 | | B | | |
| 3 | 90.00 | 4 | 1.11 | | | C | |
| 4 | 93.00 | 4 | 1.11 | | | C | D |
| 5 | 96.25 | 4 | 1.11 | | | | D |

Analysis of Variance

| Variable | N | R^{a} | R^{a} Aj | CV |
|---|---|---|---|---|
| Portulaca oleracea | 20 | 1.00 | 0.99 | 3.88 |

Table of Analysis of Variance (SC type III)

| F.V. | SC | gl | CM | F | p-value |
|---|---|---|---|---|---|
| Model | 25964.90 | 7 | 3709.27 | 500.69 | <0.0001 |
| Treatment | 26948.30 | 4 | 6487.08 | 875.65 | <0.0001 |
| Replication | 16.60 | 3 | 5.53 | 0.75 | 0.5447 |
| Error | 88.90 | 12 | 7.41 | | |
| Total | 26053.80 | 19 | | | |

Test: LSD Fisher Alpha = 0.05 DMS = 4.19339
Error: 7.4083 gl: 12

| | | | |
|---|---|---|---|
| Treatment | Mean | n | E.E. |

| | | | | | | | |
|---|---|---|---|---|---|---|---|
| 1 | 0.00 | 4 | 1.36 | A | | | |
| 2 | 73.00 | 4 | 1.36 | | B | | |
| 3 | 86.25 | 4 | 1.36 | | | C | |
| 4 | 95.00 | 4 | 1.36 | | | | D |
| 5 | 96.25 | 4 | 1.36 | | | | D |

Analysis of Variance

| Variable | N | R^{a} | R^{a}Aj | CV |
|---|---|---|---|---|
| Amaranthus hybridus | 20 | 0.99 | 0.99 | 4.74 |

Table of Analysis of Variance (SC type III)

| F.V. | SC | gl | CM | F | p-value |
|---|---|---|---|---|---|
| Model | 23885.80 | 7 | 3412.26 | 321.41 | <0.0001 |
| Replication | 39.60 | 3 | 13.20 | 1.24 | 0.3372 |
| Treatment | 23846.20 | 4 | 5961.55 | 561.53 | <0.0001 |
| Error | 127.40 | 12 | 10.62 | | |
| Total | 24013.20 | 19 | | | |

Test: LSD Fisher Alpha = 0.05 DMS = 5.01995
Error: 10.6167 gl: 12

| | | | |
|---|---|---|---|
| Treatment | Mean | n | E.E. |

| | | | | | | | |
|---|---|---|---|---|---|---|---|
| 1 | 0.00 | 4 | 1.63 | A | | | |
| 2 | 81.75 | 4 | 1.63 | | B | | |
| 3 | 83.75 | 4 | 1.63 | | B | C | |
| 4 | 88.75 | 4 | 1.63 | | | C | D |
| 5 | 89.75 | 4 | 1.63 | | | | D |

Analysis of Variance

| Variable | N | R^{a} | R^{a} Aj | CV |
|---|---|---|---|---|
| Amaranthus hybridus | 20 | 1.00 | 0.99 | 3.16 |

Table of Analysis of Variance (SC type III)

| F.V. | SC | gl | CM | F | p-value |
|---|---|---|---|---|---|
| Model | 24824.90 | 7 | 3546.41 | 722.53 | <0.0001 |
| Replication | 6.60 | 3 | 2.20 | 0.45 | 0.7231 |
| Treatment | 24818.30 | 4 | 6204.58 | 1264.09 | <0.0001 |
| Error | 58.90 | 12 | 4.91 | | |
| Total | 24883.80 | 19 | | | |

Test: LSD Fisher Alpha = 0.05 DMS = 3.41328
Error: 4.9083 gl: 12

| | | | |
|---|---|---|---|
| Treatment | Mean | n | E.E. |

| | | | | | | | |
|---|---|---|---|---|---|---|---|
| 1 | 0.00 | 4 | 1.11 | A | | | |
| 2 | 81.25 | 4 | 1.11 | | B | | |
| 3 | 87.50 | 4 | 1.11 | | | C | |
| 4 | 90.50 | 4 | 1.11 | | | C | D |
| 5 | 91.25 | 4 | 1.11 | | | | D |

Analysis of Variance

| Variable | N | R^{a} | R^{a}Aj | CV |
|---|---|---|---|---|
| Amaranthus hybridus | 20 | 1.00 | 1.00 | 3.54 |

Table of Analysis of Variance (SC type III)

| F.V. | SC | gl | CM | F | p-value |
|---|---|---|---|---|---|
| Model. | 25846.15 | 7 | 3692.31 | 579.94 | <0.0001 |
| Replication | 55.35 | 3 | 18.45 | 2.90 | 0.0789 |
| Treatment | 25790.80 | 4 | 6447.70 | 1012.73 | <0.0001 |
| Error | 76.40 | 12 | 6.37 | | |
| Total | 25922.55 | 19 | | | |

Test: LSD Fisher Alpha = 0.05 DMS = 3.88742
Error: 6.3667 gl: 12

| | | | |
|---|---|---|---|
| Treatment | Mean | n | E.E. |

| | | | | | | | |
|---|---|---|---|---|---|---|---|
| 1 | 0.00 | 4 | 1.26 | A | | | |
| 2 | 82.50 | 4 | 1.26 | | B | | |
| 3 | 87.50 | 4 | 1.26 | | | C | |
| 5 | 92.50 | 4 | 1.26 | | | | D |
| 4 | 94.25 | 4 | 1.26 | | | | D |

Analysis of Variance

| Variable | N | R^{a} | R^{a}Aj | CV |
|---|---|---|---|---|
| Amaranthus hybridus | 20 | 0.99 | 0.98 | 6.84 |

Table of Analysis of Variance (SC type III)

| F.V. | SC | gl | CM | F | p-value |
|---|---|---|---|---|---|
| Model | 21700.00 | 7 | 3100.00 | 161.74 | <0.0001 |
| Replication | 270.00 | 3 | 90.00 | 4.70 | 0.0216 |
| Treatment | 21430.00 | 4 | 5357.50 | 279.52 | <0.0001 |
| Error | 230.00 | 12 | 19.17 | | |
| Total | 21930.00 | 19 | | | |

Test: LSD Fisher Alpha = 0.05 DMS = 6.74494
Error: 19.1667 gl: 12

| | | | |
|---|---|---|---|
| Treatment | Mean | n | E.E. |

| | | | | | | | |
|---|---|---|---|---|---|---|---|
| 1 | 0.00 | 4 | 2.19 | A | | | |
| 2 | 67.50 | 4 | 2.19 | | B | | |
| 3 | 80.00 | 4 | 2.19 | | | C | |
| 5 | 85.00 | 4 | 2.19 | | | C | D |
| 4 | 87.50 | 4 | 2.19 | | | | D |

Analysis of Variance

| Variable | N | R^{a} | R^{a}Aj | CV |
|---|---|---|---|---|
| Amaranthus hybr idus | 20 | 0.99 | 0.98 | 6.94 |

Table of Analysis of Variance (SC type III)

| F.V. | SC | gl | CM | F | p-value |
|---|---|---|---|---|---|
| Model | 24652.50 | 7 | 3521.79 | 157.99 | <0.0001 |
| Replication | 320.00 | 3 | 106.67 | 4.79 | 0.0204 |
| Treatment | 24332.50 | 4 | 6083.13 | 272.89 | <0.0001 |
| Error | 267.50 | 12 | 22.29 | | |
| Total | 24920.00 | 19 | | | |

Test: LSD Fisher Alpha = 0.05 DMS = 7.27405
Error: 22.2917 gl: 12

| Treatment | Mean | n | E.E. | | | |
|---|---|---|---|---|---|---|
| 1 | 0.00 | 4 | 2.36 | A | | |
| 2 | 70.00 | 4 | 2.36 | | B | |
| 3 | 88.75 | 4 | 2.36 | | | C |
| 4 | 90.00 | 4 | 2.36 | | | C |
| 5 | 91.25 | 4 | 2.36 | | | C |

Analysis of Variance

| Variable | N | R^{a} | R^{a}Aj | CV |
|---|---|---|---|---|
| Amaranthus hybridus | 20 | 0.99 | 0.98 | 7.02 |

Table of Analysis of Variance (SC type III)

| F.V. | SC | gl | CM | F | p-value |
|---|---|---|---|---|---|
| Model. | 24072.50 | 7 | 3436.93 | 160.26 | <0.0001 |
| Replication | 30.00 | 3 | 10.00 | 0.47 | 0.7114 |
| Treatment | 24042.50 | 4 | 6010.63 | 280.11 | <0.0001 |
| Error | 257.50 | 12 | 21.46 | | |
| Total | 24330.00 | 19 | | | |

Test: LSD Fisher Alpha = 0.05 DMS = 7.13679
Error: 21.4583 gl: 12

| | | | | | | | |
|---|---|---|---|---|---|---|---|
| 1 | 0.00 | 4 | 2.32 | A | | | |
| 2 | 63.75 | 4 | 2.32 | | B | | |
| 3 | 82.50 | 4 | 2.32 | | | C | |
| 4 | 87.50 | 4 | 2.32 | | | C | |
| 5 | 96.25 | 4 | 2.32 | | | | D |

### Final Conclusions of the Comparative Tests 1) to 5)

From conclusions of the previous tests, the inventors of the present invention unexpectedly found that when micro-emulsion of promethrin was used at low concentration, it had a reduction in the application dose compared to using promethrin 50 EC in the treatment of weeds of the sunflower.

This result is not expected since the active ingredient used in both cases is the same and the person skilled in the art would suppose that both types of formulation would be applied at the same dose.

In addition to the above-described main advantage of showing a reduction in the application dose, and thanks to the combination of the other components of the micro-emulsion formulations that the researchers used for this embodiment, the present micro-emulsion formulation of promethrin offered protection against physicochemical losses (evaporation, rolling, etc.); improvement of the absorption rate; significant reduction of the environmental impact variables; drastic reduction of solvent evaporation; allowing the active ingredients to be kept in the liquid phase; allowing hydrophobic actives to solubilize in water; a large increase in the Surface/Volume ratio and controlled release of active ingredients.

Combination of Promethrin Compositions in Micro-Emulsion Form with Glyphosate and 2-4 D Compositions

The micro-emulsion compositions of promethrin developed in the present description were combined with commercial compositions of glyphosate potassium salt 54% w/v and 2.4 D 30% w/v ME at different volume ratios in binary and ternary compositions, measuring stability in hours by means of the Emulsion Test, in all cases it was found that the mixture unexpectedly showed comparable stability within 12 to 20 hours after preparation, which is a more than acceptable time to mix the products in formulation tanks to the corresponding dilution to apply to the crops.

For example, for a 40 L broth having three components it would be 32.3 L of water+3.5 L of Promethrin 18.5% ME+2.5 L Glyphosate 54% SL+1.3 L 2.4 D 30% ME. For an 80 L broth having three components it would be 72, L of water+3.5 L of Promethrin 18.5% ME+2.5 L Glyphosate 54% SL+1.3 L 2.4 D 30% ME.

The results obtained are shown in the following Table:

| | | | | Result of | | Result of | | Result of | |
|---|---|---|---|---|---|---|---|---|---|
| | | % v/v | | the broth | | the broth | | the broth | |
| | | among | | with final | | with final | | with final | |
| | | plant | | volume with | | volume with | | volume with | |
| | Amount | protecttion | | water of | Broth | water of | Broth | water of | Broth |
| Trials | ml | agents | Formulated | 8 0 ml | stability | 100 ml | stability | 8 0 ml | stability |
| 1 | 3.5 | 100 | Promethrin | Opalescent | 24 h | Opalescent | 24 h | Opalescent | 16 h |
| | | | 18.5% p/V | microemulsion | | microemulsion | | microemulsion | |
| | | | ME | | | | | | |
| 2 | 3.5 | 58.3 | Promethrin | Opalescent | 24 h | Opalescent | 24 h | Opalescent | 14 h |
| | | | 18.5% p/V | microemulsion | | microemulsion | | microemulsion | |
| | | | ME | | | | | | |
| | 2.5 | 41.7 | Glyphosate | | | | | | |
| | | | potassium | | | | | | |
| | | | salt 54% | | | | | | |
| | | | p/V | | | | | | |
| 3 | 3.5 | 58.3 | Promethrin | Crystalline | 24 h | Crystalline | 24 h | Crystalline | 16 h |
| | | | 18.5% p/V | microemulsion | | microemulsion | | microemulsion | |
| | | | ME | | | | | | |
| | 1.3 | 41.7 | 2,4-D 30% | | | | | | |
| | | | p/V ME | | | | | | |
| 4 | 3.5 | 47.9 | Promethrin | Crystalline | 24 h | Crystalline | 24 h | Opalescent | 16 h |
| | | | 18.5% p/V | microemulsion | | microemulsion | | microemulsion | |
| | | | ME | | | | | | |
| | 2.5 | 34.2 | Glyphosate | | | | | | |
| | | | potassium | | | | | | |
| | | | salt 54% | | | | | | |
| | | | p/V | | | | | | |
| | 1.3 | 17.8 | 2,4-D 30% | | | | | | |
| | | | p/V ME | | | | | | |
| 5 | 3.5 | 100 | Promethrin | Opalescent | 24 h | Opalescent | 24 h | Opalescent | 20 h |
| | | | 15% p/V ME | microemulsion | | microemulsion | | microemulsion | |
| 6 | 3.5 | 58.3 | Promethrin | Opalescent | 24 h | Opalescent | 24 h | Opalescent | 18 h |
| | | | 15% p/V ME | microemulsion | | microemulsion | | microemulsion | |
| | 2.5 | 41.7 | Glyphosate | | | | | | |
| | | | potassium | | | | | | |
| | | | salt 54% | | | | | | |
| | | | p/V | | | | | | |
| 7 | 3.5 | 58.3 | Promethrin | Crystalline | 24 h | Crystalline | 24 h | Crystalline | 20 h |
| | | | 15% p/V ME | microemulsion | | microemulsion | | microemulsion | |
| | 1.3 | 41.7 | 2,4-D 30% | | | | | | |
| | | | p/V ME | | | | | | |
| 8 | 3.5 | 47.9 | Promethrin | Crystalline | 24 h | Crystalline | 24 h | Opalescent | 20 h |
| | | | 15% p/V ME | microemulsion | | microemulsion | | microemulsion | |
| | 2.5 | 34.2 | Glyphosate | | | | | | |
| | | | potassium | | | | | | |
| | | | salt 54% | | | | | | |
| | | | p/V | | | | | | |
| | 1.3 | 17.8 | 2,4-D 30% | | | | | | |
| | | | p/V ME | | | | | | |
| 9 | 3.5 | 100 | Promethrin | Opalescent | 20 h | Opalescent | 24 h | Opalescent | 12 h |
| | | | 20% p/V ME | microemulsion | | microemulsion | | microemulsion | |
| 10 | 3.5 | 58.3 | Promethrin | Opalescent | 20 h | Opalescent | 24 h | Opalescent | 12 h |
| | | | 20% p/V ME | microemulsion | | microemulsion | | microemulsion | |
| | 2.5 | 41.7 | Glyphosate | | | | | | |
| | | | potassium | | | | | | |
| | | | salt 54% | | | | | | |
| | | | p/V | | | | | | |
| 11 | 3.5 | 58.3 | Promethrin | Crystalline | 24 h | Crystalline | 24 h | Opalescent | 16 h |
| | | | 20% p/V ME | microemulsion | | microemulsion | | microemulsion | |
| | 1.3 | 41.7 | 2,4-D 30% | | | | | | |
| | | | p/V ME | | | | | | |
| 12 | 3.5 | 47.9 | Promethrin | Opalescent | 24 h | Crystalline | 24 h | Opalescent | 14 h |
| | | | 20% p/V ME | microemulsion | | microemulsion | | microemulsion | |
| | 2.5 | 34.2 | Glyphosate | | | | | | |
| | | | potassium | | | | | | |
| | | | salt 54% | | | | | | |
| | | | p/V | | | | | | |
| | 1.3 | 17.8 | 2,4-D 30% | | | | | | |
| | | | p/V ME | | | | | | |

* Opalescent microemulsion means stable microemulsion has light white color
* Crystalline microemulsion means stable microemulsion

1. A composition of promethrin in form of a microemulsion comprising from 15 to 20% by volume by weight of promethrin, a non-polar solvent or non-polar solvent mixture comprising from 47 to 58% w/v, a polar solvent or mixture of polar solvent comprising from 2 to 21% w/v, an 60% or 70% w/w anionic surfactant comprising from 2.4 to 4.33% w/v, an adjuvant from 0 to 4.70% w/v, and a mixture of nonionic surfactants from 9.66 to 21.00% w/v.

2. The composition of promethrin in form of a microemulsion according to claim 1, wherein the non-polar solvent or non-polar solvent mixture comprises xylene and/or cyclohexanone and/or ethyl acetate and/or coconut fatty acid dimethylamide of 8-10 carbon atoms.

3. The composition of promethrin in form of a microemulsion according to claim 1, wherein the polar solvent or polar solvent mixture comprises water and/or propylene glycol.

4. The composition of promethrin in form of a microemulsion according to claim 1, wherein the 60% or 70% w/w anionic surfactant is calcium dodecylbenzenesulfonate.

5. The composition of promethrin in form of a microemulsion according to claim 1, wherein the mixture of nonionic surfactants comprises castor oil ethoxylated with 36 moles of ethylene oxide and/or tristyryl phenol ethoxylated with 20 moles of oxide of ethylene and/or tridecyl alcohol ethoxylated with 6 moles of ethylene oxide and/or polymeric polyalkylene glycol ether.

6. The composition of promethrin in form of a microemulsion according to claim 1, wherein the adjuvant is a soybean oil fatty acid methyl ester.

7. The composition of promethrin in form of a microemulsion according to claim 1, wherein the concentration of promethrin is 18.5% w/v.

8. The composition of promethrin in form of a microemulsion according to claim 7, comprising the following ratio of components: 18.5% w/v of promethrin, 39% w/v of xylene, 16.5% w/v of cyclohexanone, 2% w/v of ethyl acetate, 2% w/v of soybean oil fatty acid methyl ester, 4.33% w/v of tridecyl alcohol ethoxylated with 6 moles of ethylene oxide, 4.33% w/v of calcium dodecylbenzenesulfonate (60% w/w), 4.33% w/v of castor oil ethoxylated with 36 moles of ethylene oxide, 1.0% w/v of tristyryl phenol ethoxylated with 20 moles of ethylene oxide and 5% w/v of propylene glycol.

9. The composition of promethrin in form of a microemulsion according to claim 7, comprising the following component ratio: 18.5% w/v of promethrin, 43% w/v of xylene, 17% w/v of cyclohexanone, 2% w/v of ethyl acetate, 0% w/v of soybean oil fatty acid methyl ester, 4.33% w/v tridecyl alcohol ethoxylated with 6 moles of ethylene oxide, 4.33% w/v of calcium dodecylbenzenesulfonate (60% w/w), 4.33% w/v of castor oil ethoxylated with 36 moles ethylene oxide, 1.0% w/v tristyryl phenol ethoxylated 20 moles ethylene oxide and 2% w/v of propylene glycol.

10. The composition of promethrin in form of a microemulsion according to claim 7, comprising the following component ratio: 18.5% w/v of promethrin, 46.6% w/v of xylene, 3.5% of water, 4.70% w/v of soybean oil fatty acid methyl ester, 2.40% w/v of calcium dodecylbenzenesulfonate (60% w/w), 4.70% w/v of polymeric polyalkylene glycol ether, 12.20% w/v of tristyryl phenol ethoxylated with 20 moles of ethylene oxide and 2.80% w/v of propylene glycol.

11. The composition of promethrin in form of a microemulsion according to claim 7, comprising the following component ratio: 18.5% w/v of promethrin, 47% w/v of xylene, 3.50% w/v of water, 2% w/v of soybean oil fatty acid methyl ester, 5.0% w/v of polymeric polyalkylene glycol ether, 16.0% w/v of triestyryl phenol ethoxylated with 20 moles of ethylene oxide and 21.0% w/v of propylene glycol.

12. The composition of promethrin in form of a microemulsion according to claim 7, comprising the following component ratio: 18.5% w/v of promethrin, 47.70% w/v of xylene, 2.00% w/v of water, 3.70% w/v of soybean oil fatty acid methyl ester, 1.50% w/v of tridecyl alcohol ethoxylated with 6 moles of ethylene oxide, 2.40% w/v of calcium dodecylbenzenesulfonate (70% w/w), 4.70% w/v of polymeric polyalkylene glycol ether, and 12.2% w/v of triestyryl phenol ethoxylated with 20 moles of ethylene oxide.

13. The composition of promethrin in form of a microemulsion according to claim 7, comprising the following component ratio: 18.5% w/v of promethrin, 49.0% w/v of coconut fatty acid dimethylamide with 8-10 carbon atoms, 1.00% w/v of soybean oil fatty acid methyl ester, 1.5% w/v of propylene glycol, 15.00% w/v of triestyryl phenol ethoxylated with 20 moles of ethylene oxide, 3.30% w/v of calcium dodecylbenzenesulfonate (70% w/w), 6.00% w/v of polymeric polyalkylene glycol ether, and 2.00% w/v of water.

14. The composition of promethrin in form of a microemulsion according to claim 7, comprising the following component ratio: 18.5% w/v of promethrin, 48.0% w/v of coconut fatty acid dimethylamide with 8-10 carbon atoms, 2.00% w/v of soybean oil fatty acid methyl ester, 2.5% w/v of propylene glycol, 16.00% w/v of tristyryl phenol ethoxylated with 20 moles of ethylene oxide, 2.50% w/v of calcium dodecylbenzenesulfonate (70% w/w), 5.00% w/v of polymeric polyalkylene glycol ether, and 2.50% w/v of water.

15. The composition of promethrin in form of a microemulsion according to claim 1, comprising the following ratio of components: 15.0% w/v of promethrin, 40% w/v of xylene, 17.80% w/v of cyclohexanone, 2.00% w/v of ethyl acetate, 2.00% w/v of soybean oil fatty acid methyl ester, 4.33% w/v of tridecyl alcohol ethoxylated with 6 moles of ethylene oxide, 4.33% w/v of calcium dodecylbenzenesulfonate (60% w/w), 4.33% w/v of castor oil ethoxylated with 36 moles of ethylene oxide, 1.0% w/v of tristyryl phenol ethoxylated with 20 moles of ethylene oxide and 5% w/v of propylene glycol.

16. The composition of promethrin in form of a microemulsion according to claim 1, comprising the following ratio of components: 20.00% w/v of promethrin, 39% w/v of xylene, 15% w/v of cyclohexanone, 2% w/v of ethyl acetate, 2% w/v of soybean oil fatty acid methyl ester, 4.33% w/v of tridecyl alcohol ethoxylated with 6 moles oxide of ethylene, 4.33% w/v of calcium dodecylbenzenesulfonate (60% w/w), 4.33% w/v of castor oil ethoxylated with 36 moles of ethylene oxide, 1.0% w/v of tristyryl phenol ethoxylated with 20 moles of ethylene oxide and 5% w/v of propylene glycol.

17. The composition of promethrin in form of a microemulsion according to claim 1, combined with compositions of 2,4-D and/or glyphosate before dilution with water for subsequent application.

18. The composition of promethrin in form of a microemulsion according to claim 17, wherein the composition of promethrin in form of a microemulsion comprises compositions with a concentration of 18.5% w/v, 15% w/v, and 20% w/v; the glyphosate composition comprises glyphosate potassium salt 54% w/v and the 2,4-D composition comprises 2,4-D 30% w/v of microemulsion.

19. The composition of promethrin in form of a microemulsion according to claim 17, wherein the combination ratio of the promethrin composition:glyphosate composition in a binary mixture is 58.3:41.7 v/v.

20. The composition of promethrin in form of a microemulsion according to claim 17, wherein the combination ratio of the promethrin composition: 2,4-D composition in a binary mixture is 72.9:27.1 v/v.

21. The composition of promethrin in form of a microemulsion according to claim 17, wherein the combination ratio of the promethrin composition:glyphosate composition:2,4-D composition in a ternary mixture is 47.9:34.2:17.9 v/v.
